(19) United States
(12) Patent Application Publication
(10) Pub. No.: US 2026/0270426 A1
(43) Pub. Date: Sep. 10, 2026

(54) METHOD FOR DECODING DATA, ENCODING DATA AND RELATED DEVICE

(71) Applicant: HUAWEI TECHNOLOGIES CO., LTD., Shenzhen (CN)

(72) Inventors: Johannes Sauer, Munich (DE); Timofey Mikhailovich Solovyev, Munich (DE); Elena Alexandrovna Alshina, Munich (DE); Alexander Alexandrovich Karabutov, Munich (DE); Yin Zhao, Hangzhou (CN); Jue Mao, Hangzhou (CN)

(73) Assignee: HUAWEI TECHNOLOGIES CO., LTD., Shenzhen (CN)

(21) Appl. No.: 19/658,165

(22) Filed: Apr. 24, 2026

Related U.S. Application Data
(63) Continuation of application No. PCT/CN2024/073066, filed on Jan. 18, 2024.

(30) Foreign Application Priority Data
Oct. 26, 2023 (WO) PCT/CN2023/126869

(51) Int. Cl. H04N 19/119; G06N 3/0455; H04N 19/70

(52) U.S. Cl. CPC H04N 19/119; G06N 3/0455; H04N 19/70

(57) ABSTRACT

Embodiments of the present application provide a method for decoding data, a method for encoding data, and related devices. The method for decoding data, including: obtaining an entropy segment i from a bitstream, where the entropy segment i is one entropy segment among N entropy segments, the N entropy segments constitute a representation of an input data in a latent space, the entropy segment i has no overlap region with its adjacent entropy segment, N is a positive integer greater than one, i=1, . . . , N; determining a synthesis segment i according to the entropy segment i and/or at least one entropy segment adjacent to the entropy segment i, where the synthesis segment i includes at least one overlap region with its adjacent synthesis segment; determining a reconstructed segment i according to the synthesis segment i by performing a decoding network, where the reconstructed segment i has no overlap region with its adjacent reconstructed segment. According to the method, a pipe-line processing may be performed by the decoding device.

### CROSS-REFERENCE TO RELATED APPLICATIONS

This application is a continuation of International Application No. PCT/CN2024/073066, filed on Jan. 18, 2024, which claims priority to International Patent Application No. PCT/CN2023/126869, filed on Oct. 26, 2023. The disclosures of the aforementioned applications are hereby incorporated by reference in their entireties.

### TECHNICAL FIELD

Embodiments of the present disclosure generally relate to the field of electronic engineering technologies, and more specifically, to encoding and decoding data based on a neural network architecture. In particular, some embodiments relate to methods and apparatuses for such encoding and decoding images and/or videos from a bitstream using a plurality of processing layers.

### BACKGROUND

Artificial Intelligence (AI) is a technological field dedicated to simulating and replicating human intelligence. It encompasses various aspects of building intelligent systems with the goal of enabling these systems to perform tasks and make decisions similar to humans. AI takes on various forms, including machine learning, deep learning, natural language processing, computer vision, and more.

AI has a wide range of applications and can play a significant role in numerous fields. For example, in the field of autonomous driving, the application of AI technology allows vehicles like cars and airplanes to achieve self-navigation and driving capabilities. In medical diagnostics, AI aids doctors in disease diagnosis and image interpretation through the application of machine learning and image analysis techniques, thereby improving accuracy and efficiency. Additionally, AI can be applied to machine translation, speech assistants, fraud detection in the financial sector, and more.

AI has also made groundbreaking progress in the field of data compression and encoding, providing more efficient solutions for data processing and transmission. For instance, AI technology can be applied to image compression, where deep learning algorithms identify important features in images and achieve lossless or lossy compression, reducing the size of image files. Similarly, AI can be used for video and speech compression encoding by learning relevance and redundant information, optimizing encoding parameters to make data storage and transmission more efficient. AI has undeniably made remarkable progress in the field of data compression and encoding, but to keep pace with the growing demand for data processing and transmission, continued research and innovation are necessary to enhance the efficiency of both encoding and decoding.

Hybrid image and video codecs have been used for decades to compress image and video data. In such codecs, signal is typically encoded block-wisely by predicting a block and by further coding only the difference between the original bock and its prediction. In particular, such coding may include transformation, quantization and generating the bitstream, usually including some entropy coding.

Typically, the three components of hybrid coding methods—transformation, quantization, and entropy coding—are separately optimized. Modern video compression standards like High-Efficiency Video Coding (HEVC), Versatile Video Coding (VVC) and Essential Video Coding (EVC) also use transformed representation to code residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approached have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud or between different devices, a feature map at the output of the place of splitting (e.g. a first device) is compressed and transmitted to the remaining layers of the neural network (e.g. to a second device).

Further improvement of encoding and decoding using trained network architectures may be desirable.

### SUMMARY

The present disclosure provides methods and apparatuses to improve data compression. Embodiments of the present application provide a method for decoding data, a method for encoding data, and related devices. According to the present application, a pipe-line processing may be applied by a decoding device.

The foregoing and other objects are achieved by the subject matter of the independent claims. Further implementation forms are apparent from the dependent claims, the description and the figures.

Particular embodiments are outlined in the attached independent claims, with other embodiments in the dependent claims.

According to a first aspect, the present disclosure relates to a method for decoding. The method is performed by an electronic device. According to the first aspect, an embodiment of the present application provides a decoding method, including: obtaining an entropy segment i from a bitstream, where the entropy segment i is one entropy segment among N entropy segments, the N entropy segments constitute a representation of an input data in a latent space, the entropy segment i has no overlap region with its adjacent entropy segment, N is a positive integer greater than one, i=1, . . . , N; determining a synthesis segment i according to the entropy segment i and/or at least one entropy segment adjacent to the entropy segment i, where the synthesis segment i includes at least one overlap region with its adjacent synthesis segment; determining a reconstructed segment i according to the synthesis segment i by performing a decoding network, where the reconstructed segment i has no overlap region with its adjacent reconstructed segment.

By dividing the components into multiple segments, such as tiles, can reduce the memory needed for decoding of an image. In the state-of-the art, the whole latent space needs to be parsed/read from the bitstream, before the first tile can be decoded. Embodiments of the present invention can advantageously allow for pipelined decoding and synthesis of image regions using neural networks.

The foregoing and other embodiments can each optionally include one or more of the following features, alone or in combination.

According to the method provided in the first aspect, a pipe-line processing may be performed by the decoding device. The decoding device may obtain the first synthesis segment among the M synthesis segments and obtains a reconstructed segment corresponding to the first synthesis segments, then the decoding device may obtain the second synthesis segment among the M synthesis segments and obtains a reconstructed segment corresponding to the second synthesis segments and so on. Therefore, the decoding device do not have to obtain all synthesis segments to obtain the reconstructed segments.

In a possible implementation of the first aspect, the obtaining an entropy segment i from a bitstream includes: determining a location information corresponding to the entropy segment i according to an input segment corresponding to the entropy segment i, where the input segment corresponding to the entropy segment i is one input segment among M input segments, the M input segments constitute the input data, each of the M input segments includes at least one overlap region with its adjacent input segment, M is a positive integer greater than one; obtaining the entropy segment i according to the location information corresponding to the entropy segment i from the bitstream.

In a possible implementation of the first aspect, the determining a location information corresponding to the entropy segment i according to an input segment corresponding to the entropy segment i, includes: determining a shifted segment i according to the input segment corresponding to the entropy segment i and a size of the overlap region; determining a shifted latent segment i according to the shifted segment i and an alignment parameter of a synthesis transform in the decoding network; determining the location information corresponding to the entropy segment i according to the shifted latent segment i and the shifted segment i.

In a possible implementation of the first aspect, the determining a synthesis segment i according to the entropy segment i and/or at least one entropy segment adjacent to the entropy segment i, includes: determining location information of the synthesis segment i according to an alignment parameter of a synthesis transform in the decoding network and an input segment corresponding to the synthesis segment i, where the input segment corresponding to the synthesis segment i is one input segment among M input segments, the M input segments constitute the input data, each of the M input segments includes at least one overlap region with its adjacent input segment; determining, according to the location information of the synthesis segment i, elements of the synthesis segment i from the entropy segment i and/or at least one entropy segment adjacent to the entropy segment i.

In a possible implementation of the first aspect, before the obtaining an entropy segment i from a bitstream, the method further includes: obtaining a segment flag information from the bitstream, where the segment flag information indicates that the bitstream includes N entropy segments.

In a possible implementation, the method further comprises: obtaining a first context segment i according to the entropy segment i and/or at least one entropy segment adjacent to the entropy segment i, wherein the first context segment is obtained from the bitstream and comprises at least one overlap region with an adjacent first context segment; obtaining a second context segment i according to the entropy segment and/or at least one entropy segment adjacent to the entropy segment i, wherein the second context segment represents an input prediction segment i corresponding to the entropy segment i and comprises at least one overlap region with an adjacent second context segment; inputting the first context segment i and the second context segment i to a context model to form the synthesis segment i; and determining the reconstructed segment i according to the synthesis segment i by inputting the synthesis segment i into the decoding network, wherein the reconstructed segment i has no overlap region with its adjacent reconstructed segment.

This may allow a context model to be used as part of the decoder whilst allowing pipelining of the synthesis process. Using a context module may allow for a better prediction, which leads to a smaller of additional information that needs to be encoded and decoded, i.e. for a similar quality, the required bitrate is smaller.

In a possible implementation, the first context segment i has the same spatial dimension as the synthesis segment i. This may allow a synthesis segment to be produced that has at least one overlap region with one or more adjacent synthesis segments.

In a possible implementation, the first context segment i and the second context segment i each have the same total numbers of elements. This may allow the first and second context segments to be used as inputs to the context model to output a synthesis segment that has the same spatial dimension as the first context segment.

In a possible implementation, the input prediction segment is the output of a hyper-decoder of a variational auto encoder model. The use of an input prediction segment from the output of the hyper-decoder as input to a context model may improve the accuracy of the final prediction.

In a possible implementation, the spatial dimension of the second context segment i is a quarter of the spatial dimension of the first context segment I, and the second context segment i has 4 times the number of channels than the first context segment. This may allow for rearrangement of elements in a tensor when inputting the first and second context segments to the context model.

In a possible implementation, the first context segment i represents a residual of the input data in the latent space. The use of a residual rather than the full data may reduce the bitrate required for processing.

In a possible implementation, the at least one overlap region of the synthesis segment is disregarded in the determination of the reconstructed segment. This may prevent redundant computation in the determination of the reconstructed segment.

In a possible implementation, the input data is derived from an input image and each reconstructed segment may correspond to a tile of the input image. This may allow the approach to be used in image reconstruction applications, optionally with a context module.

According to a second aspect, the present disclosure relates to a method for encoding. The method is performed by an electronic device. According to the second aspect, an embodiment of the present application provides an encoding method, including: dividing an input data into M input segments, where each of the M input segments includes at least one overlap region with its adjacent input segment, M is a positive integer greater than one; determining M analysis segments by processing the M input segments using an encoding network, where the M analysis segments and the M input segments are in one-to-one correspondence; determining a representation of the input data in a latent space according to the M analysis segments and the M input segments; dividing the representation of the input data into N entropy segments, where each of the N entropy segments has no overlap region with its adjacent entropy segment, N is a positive integer greater than one; determining a bitstream by encoding the N entropy segments.

The foregoing and other embodiments can each optionally include one or more of the following features, alone or in combination.

According to the method provided in the first aspect and/or the second aspect, the overlap regions in the input segments are removed. Therefore, the overlap regions do not need to be written into the bitstream several time. The length of the bitstream may be decrease and time consuming for construct the bitstream may be decreased as well. Correspondingly, the overlap regions do not need to be read from the bitstream several times. The decoding device may decode the bitstream in a pipeline method.

In a possible implementation of the second aspect, the determining a representation of the input data in a latent space according to the M analysis segments, includes: determining M core segments according to the M analysis segments and the M input segments, where a jth core segments among the M core segments is determined according to a jth analysis segments among the M analysis segments and a jth input segment among the M input segments, j=1, . . . , M, each of the M core segments has no overlap region with its adjacent core segments; determining the representation of the input data by constitute the M core segments.

In a possible implementation of the second aspect, the dividing the representation of the input data into N entropy segments, includes: determining location information of each of the N entropy segments; dividing, according to location information of the each of the N entropy segments, the representation of the input data into the N entropy segments.

In a possible implementation of the second aspect, the determining location information of each of the N entropy segments, includes: determining N shifted segments according to the M input segments; determining N shifted latent segments according to the N shifted segments and an alignment parameter of an analysis transform in the encoding network; determining the location information of the each of the N entropy segments according to the N shifted latent segments and the N shifted segments.

In a possible implementation of the second aspect, the method further includes: determining a segment flag information in the bitstream, where the segment flag information indicates that the bitstream includes N entropy segments.

In a possible implementation, the method further comprises: from the determined representation of the input data in the latent space, determining a latent segment i, i=1, . . . , M, wherein the latent segment i comprises at least one overlap region with its adjacent latent segment; obtaining an input prediction segment i according to the latent segment i, the input prediction segment i comprising at least one overlap region with an adjacent input prediction segment; inputting the latent segment i and the input prediction segment i to a context model to output an output segment i of M output segments, wherein the output segment i has no overlap region with its adjacent output segment; dividing the M output segments into N entropy segments, wherein each of the N entropy segments has no overlap region with its adjacent entropy segment; and determining the bitstream by encoding the N entropy segments. This may allow a context model to be used as part of the decoder whilst allowing pipelining of the synthesis process. Using a context module may allow for a better prediction, which leads to a smaller of additional information that needs to be encoded and decoded, i.e. for a similar quality, the required bitrate is smaller.

In a possible implementation, the latent segment i has the same spatial dimension as the output segment i. This may allow an output segment to be produced that has at least one overlap region with one or more adjacent output segments.

In a possible implementation, the latent segment i and the input prediction segment i each have the same total numbers of elements. This may allow the latent segment and the input prediction segment to be used as inputs to the context model to give an output segment that has the same spatial dimension as the latent segment.

In a possible implementation, the input prediction segment is the output of a hyper-decoder of a variational auto encoder model. The use of an input prediction segment from the output of the hyper-decoder as an input to a context model may improve the accuracy of the final prediction.

In a possible implementation, the spatial dimension of the input prediction segment i is a quarter of the spatial dimension of the latent segment i. The input prediction segment i may have 4 times the number of channels than the latent segment. This may allow for rearrangement of elements in a tensor when inputting the input prediction segment and the latent segment to the context model.

In a possible implementation, the output segment i represents a residual of the input data in the latent space. The use of a residual rather than the full data may reduce the bitrate required for processing.

In a possible implementation, the at least one overlap region of the latent segment is disregarded in the determination of the output segments. This may prevent redundant computation in the determination of the output segments.

In a possible implementation, the input data is derived from an input image and each latent segment may correspond to a tile of the input image. This may allow the approach to be used in image reconstruction applications, optionally with a context module.

According to a third aspect, the present disclosure relates to an apparatus for decoding. Such apparatus for decoding may refer to the same advantageous effect as the method for decoding according to the first aspect. Details are not described herein again. The decoding apparatus provides technical means for implementing an action in the method defined according to the first aspect. The function may be implemented by hardware, or may be implemented by hardware executing corresponding software. In a possible implementation, the decoding apparatus includes: an obtaining unit, configured to obtain an entropy segment i from a bitstream, wherein the entropy segment i is one entropy segment among N entropy segments, the N entropy segments constitute a representation of an input data in a latent space, the entropy segment i has no overlap region with its adjacent entropy segment, N is a positive integer greater than one, i=1, . . . , N; a processing unit, configured to determine a synthesis segment i according to the entropy segment i and/or at least one entropy segment adjacent to the entropy segment i, wherein the synthesis segment i comprises at least one overlap region with its adjacent synthesis segment; the processing unit, further configured to determine a reconstructed segment i according to the synthesis segment i by performing a decoding network, wherein the reconstructed segment i has no overlap region with its adjacent reconstructed segment.

These modules may be adapted to provide respective functions which correspond to the method example according to the first aspect. For details, it is referred to the detailed descriptions in the method example. Details are not described herein again.

According to the third aspect, an embodiment of the present application provides an electronic device, and the electronic device has a function of implementing the method in the first aspect. The function may be implemented by hardware, or may be implemented by hardware executing corresponding software. The hardware of the software includes one or more units corresponding to the function.

The foregoing and other embodiments can each optionally include one or more of the following features, alone or in combination.

In a possible implementation, the device is further configured to: obtain a first context segment i according to the entropy segment i and/or at least one entropy segment adjacent to the entropy segment i, wherein the first context segment is obtained from the bitstream and comprises at least one overlap region with an adjacent first context segment; obtain a second context segment i according to the entropy segment and/or at least one entropy segment adjacent to the entropy segment i, wherein the second context segment represents an input prediction segment i corresponding to the entropy segment i and comprises at least one overlap region with an adjacent second context segment; input the first context segment i and the second context segment i to a context model to form the synthesis segment i; and wherein the processing unit is further configured to determine the reconstructed segment i according to the synthesis segment i by inputting the synthesis segment i into the decoding network, wherein the reconstructed segment i has no overlap region with its adjacent reconstructed segment. This may allow a context model to be used as part of the encoder whilst allowing pipelining of the synthesis process. Using a context module may allow for a better prediction, which leads to a smaller of additional information that needs to be encoded and decoded, i.e. for a similar quality, the required bitrate is smaller.

In a possible implementation, the first context segment i has the same spatial dimension as the synthesis segment i. This may allow a synthesis segment to be produced that has at least one overlap region with one or more adjacent synthesis segments.

In a possible implementation, the first context segment i and the second context segment i each have the same total numbers of elements. This may allow the first and second context segments to be used as inputs to the context model to give a synthesis segment that has the same spatial dimension as the first context segment.

In a possible implementation, the input prediction segment is the output of a hyper-decoder of a variational auto encoder model. The use of an input prediction segment from the output of the hyper-decoder to a context model may improve the accuracy of the final prediction.

In a possible implementation, the spatial dimension of the second context segment i is a quarter of the spatial dimension of the first context segment i, and wherein the second context segment i has 4 times the number of channels than the first context segment. This may allow for rearrangement of elements in a tensor when inputting the first and second context segments to the context model.

In a possible implementation, the first context segment i represents a residual of the input data in the latent space. The use of a residual rather than the full data may reduce the bitrate required for processing.

In a possible implementation, the processing unit is further configured to disregard the at least one overlap region of the synthesis segment in the determination of the reconstructed segment. This may prevent redundant computation in the determination of the reconstructed segments.

In a possible implementation, the input data is derived from an input image and each reconstructed segment may correspond to a tile of the input image. This may allow images to be reconstructed using a pipelined decoding and synthesis procedure, optionally with a context module.

According to a fourth aspect, the present disclosure relates to an apparatus for encoding. Such apparatus for encoding may refer to the same advantageous effect as the method for encoding according to the second aspect. Details are not described herein again. The encoding apparatus provides technical means for implementing an action in the method defined according to the second aspect. The function may be implemented by hardware, or may be implemented by hardware executing corresponding software. In a possible implementation, the encoding apparatus includes: a dividing unit, configured to divide an input data into M input segments, wherein each of the M input segments comprises at least one overlap region with its adjacent input segment, M is a positive integer greater than one; a processing unit configured to determine M analysis segments by processing the M input segments using an encoding network, wherein the M analysis segments and the M input segments are in one-to-one correspondence; the processing unit, further configured to determine a representation of the input data in a latent space according to the M analysis segments and the M input segments; the processing unit, further configured to divide the representation of the input data into N entropy segments, wherein each of the N entropy segments has no overlap region with its adjacent entropy segment, N is a positive integer greater than one; the processing unit, further configured to determine a bitstream by encoding the N entropy segments.

These modules may be adapted to provide respective functions which correspond to the method example according to the second aspect. For details, it is referred to the detailed descriptions in the method example. Details are not described herein again.

According to the fourth aspect, an embodiment of the present application provides an electronic device, and the electronic device has a function of implementing the method in the second aspect. The function may be implemented by hardware, or may be implemented by hardware executing corresponding software. The hardware of the software includes one or more units corresponding to the function.

The foregoing and other embodiments can each optionally include one or more of the following features, alone or in combination.

In a possible implementation, the device is further configured to: from the determined representation of the input data in the latent space, determine a latent segment i, i=1, . . . , M, wherein the latent segment i comprises at least one overlap region with its adjacent latent segment; obtain an input prediction segment i according to the latent segment i, the input prediction segment i comprising at least one overlap region with an adjacent input prediction segment; input the latent segment i and the input prediction segment i to a context model to output an output segment i of M output segments, wherein the output segment i has no overlap region with its adjacent output segment; divide the M output segments into N entropy segments, wherein each of the N entropy segments has no overlap region with its adjacent entropy segment; and determine the bitstream by encoding the N entropy segments. This may allow a context model to be used as part of the encoder whilst allowing pipelining of the synthesis process. Using a context module may allow for a better prediction, which leads to a smaller of additional information that needs to be encoded and decoded, i.e. for a similar quality, the required bitrate is smaller.

In a possible implementation, the latent segment i has the same spatial dimension as the output segment i. This may allow an output segment to be produced that has at least one overlap region with one or more adjacent output segments.

In a possible implementation, the latent segment i and the input prediction segment i each have the same total numbers of elements. This may allow the latent segments and input prediction segments to be used as inputs to the context model to give an output segment that has the same spatial dimension as the latent segment.

In a possible implementation, the input prediction segment is the output of a hyper-decoder of a variational auto encoder model. The use of an input prediction segment from the output of the hyper-decoder to a context model may improve the accuracy of the final prediction.

In a possible implementation, the spatial dimension of the input prediction segment i is a quarter of the spatial dimension of the latent segment i, and wherein the input prediction segment i has 4 times the number of channels than the latent segment. This may allow for rearrangement of elements in a tensor when inputting the input prediction segment and the latent segment to the context model.

In a possible implementation, the output segment i represents a residual of the input data in the latent space. The use of a residual rather than the full data may reduce the bitrate required for processing.

In a possible implementation, the processing unit is further configured to disregard the at least one overlap region of the latent segments in the determination of the output segments. This may prevent redundant computation in the determination of the output segments. This may reduce the bitrate in the bitstream.

In a possible implementation, the input data is derived from an input image and each latent segment may correspond to a tile of the input image. This may allow images to be reconstructed using a pipelined decoding and synthesis procedure, optionally with a context model.

According to a fifth aspect, an embodiment of the present application provides a computer readable storage medium including instructions. When the instructions run on an electronic device, the electronic device is enabled to perform the method in the first aspect or any possible implementation of the first aspect.

According to a sixth aspect, an embodiment of the present application provides a computer readable storage medium including instructions. When the instructions run on an electronic device, the electronic device is enabled to perform the method in the second aspect or any possible implementation of the second aspect.

The computer-readable storage medium has stored thereon instructions that when executed cause one or more processors to encode video data. The instructions cause the one or more processors to perform the method according to the first or second aspect or any possible embodiment of the first or second aspect.

According to a seventh aspect, an embodiment of the present application provides an electronic device, including a processor and a memory. The processor is connected to the memory. The memory is configured to store instructions, and the processor is configured to execute the instructions. When the processor executes the instructions stored in the memory, the processor is enabled to perform the method in the first aspect or any possible implementation of the first aspect.

According to an eighth aspect, an embodiment of the present application provides an electronic device, including a processor and a memory. The processor is connected to the memory. The memory is configured to store instructions, and the processor is configured to execute the instructions. When the processor executes the instructions stored in the memory, the processor is enabled to perform the method in the second aspect or any possible implementation of the second aspect.

According to a ninth aspect, an embodiment of the present application provides a chip system, where the chip system includes a memory and a processor, and the memory is configured to store a computer program, and the processor is configured to invoke the computer program from the memory and run the computer program, so that an electronic device on which the chip system is disposed performs the method in the first aspect or any possible implementation of the first aspect.

According to a tenth aspect, an embodiment of the present application provides a chip system, where the chip system includes a memory and a processor, and the memory is configured to store a computer program, and the processor is configured to invoke the computer program from the memory and run the computer program, so that an electronic device on which the chip system is disposed performs the method in the second aspect or any possible implementation of the second aspect.

According to an eleventh aspect, an embodiment of the present application provides a computer program product, where when the computer program product runs on an electronic device, the electronic device is enabled to perform the method in the first aspect or any possible implementation of the first aspect. The computer program product includes program code for performing the method according to the first aspect or any possible embodiment of the first aspect when executed on a computer.

According to a twelfth aspect, an embodiment of the present application provides a computer program product, where when the computer program product runs on an electronic device, the electronic device is enabled to perform the method in the second aspect or any possible implementation of the second aspect. The computer program product includes program code for performing the method according to the second aspect or any possible embodiment of the second aspect when executed on a computer.

The method according to the first aspect of the present disclosure may be performed by the apparatus according to the third aspect of the present disclosure. Further features and implementations of the method according to the first aspect of the present disclosure correspond to respective features and implementations of the apparatus according to the third aspect of the present disclosure. The advantages of the method according to the first aspect can be the same as those for the corresponding implementation of the apparatus according to the third aspect.

The method according to the second aspect of the present disclosure may be performed by the apparatus according to the fourth aspect of the present disclosure. Further features and implementations of the method according to the second aspect of the present disclosure correspond to respective features and implementations of the apparatus according to the fourth aspect of the present disclosure. The advantages of the method according to the second aspect can be the same as those for the corresponding implementation of the apparatus according to the fourth aspect.

According to a further aspect, the present disclosure relates to a video stream decoding apparatus, including a processor and a memory. The memory stores instructions that cause the processor to perform the method according to the first aspect.

According to a further aspect, the present disclosure relates to a video stream encoding apparatus, including a processor and a memory. The memory stores instructions that cause the processor to perform the method according to the second aspect.

According to a further aspect, the present disclosure relates to a bitstream comprising blocks of data representing N entropy segments, wherein each of the N entropy segments has no overlap region with its adjacent entropy segment, N is a positive integer greater than one.

A further embodiment of this application may provide a system for delivering a bitstream, including: at least one storage medium, configured to store at least one bitstream as defined above or as generated by the encoding method described above; a video streaming device, configured to obtain a bitstream from one of the at least one storage medium, and send the bitstream to a terminal device; where the video streaming device includes a content server or a content delivery server.

In one possible embodiment, the system may further include: one or more processor, configured to perform encryption processing on at least one bitstream to obtain at least one encrypted bitstream; the at least one storage medium, configured to store the encrypted bitstream; or, the one or more processor, configured to converting a bitstream in a first format into a bitstream in a second format; the at least one storage medium, configured to store the bitstream in the second format. In one possible embodiment, further including: a receiver, configured to receive a first operation request; and; the one or more processor, configured to determine a target bitstream in the at least one storage medium in response to the first operation request; a transmitter, configured to send the target bitstream to a terminal-side apparatus. In one possible embodiment, the one or more processor is further configured to: encapsulate a bitstream to obtain a transport stream in a first format; and the transmitter, is further configured to: send the transport stream in the first format to a terminal-side apparatus for display; or, send the transport stream in the first format to storage space for storage.

In one possible embodiment, an exemplary method for storing a bitstream is provided, the method includes: obtaining a bitstream according to any one of the encoding methods illustrated before; storing the bitstream in a storage medium. Optionally, the method further includes: performing encryption processing on the bitstream to obtain an encrypted bitstream; and; storing the encrypted bitstream in the storage medium. It should be understood that any of the known encryption methods may be employed.

In one possible embodiment, an exemplary system for storing a bitstream is provided, the system, including: a receiver, configured to receive a bitstream generated by any one of the before encoding methods; and; a processor, configured to perform encryption processing on the bitstream to obtain an encrypted bitstream; and; a computer readable storage medium, configured to store the encrypted bitstream.

Optionally, the system includes a video streaming device, where the video streaming device can be a content server or a content delivery server, where the video streaming device is configured to obtain a bitstream from the storage medium, and send the bitstream to a terminal device.

According to a further aspect, the present disclosure relates to a method of video compression for a video stream, the method comprising: receiving a bitstream as above; and decoding the bitstream to form a representation of the state of the video stream in one or more channels.

According to a further aspect, the present disclosure relates to a video stream decoding apparatus, including a processor and a memory. The memory stores instructions that cause the processor to perform the method according to the fourth aspect.

According to a further aspect, the present disclosure relates to a video stream encoding apparatus, including a processor and a memory. The memory stores instructions that cause the processor to perform the method according to the second aspect.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which:

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture for encoder and decoder side including a hyperprior model;

FIG. 3B is a schematic drawing illustrating a general network architecture for encoder side including a hyperprior model;

FIG. 3C is a schematic drawing illustrating a general network architecture for decoder side including a hyperprior model;

FIG. 4 is a schematic drawing illustrating an exemplary network architecture for encoder and decoder side including a hyperprior model;

FIG. 5 is a block diagram illustrating a structure of a cloud-based solution for machine based tasks such as machine vision tasks;

FIG. 6A is a block diagram illustrating end-to-end video compression framework based on a neural networks;

FIG. 6B is a block diagram illustrating some exemplary details of application of a neural network for motion field compression;

FIG. 6C is a block diagram illustrating some exemplary details of application of a neural network for motion compensation;

FIG. 7 is a block diagram illustrating an example of an encoding apparatus or a decoding apparatus;

FIG. 8 is a block diagram illustrating another example of an encoding apparatus or a decoding apparatus;

FIG. 9 is a diagram illustrating the calculation of total receptive field;

FIG. 10 is a diagram illustrating another calculation of total receptive field;

FIG. 11 is a schematic block diagram illustrating a coding system according to some embodiments of the present application;

FIG. 12 exemplifies the VAE framework;

FIG. 13 depicts the encoder components of the VAE framework;

FIG. 14 depicts the decoder components of the VAE framework;

FIG. 15 illustrates a general principle of compression;

FIG. 16 illustrates another VAE framework;

FIG. 17 illustrates a flowchart of an encoding method provided by some embodiments of the present application;

FIG. 18 illustrates a flowchart of a decoding method provided by some embodiments of the present application;

FIG. 19 illustrates a pipe-line procedure;

FIG. 20 illustrates the tiles for determining the reconstructed image and the tiles read from the bitstream;

FIG. 21 illustrates entropy tiles, the synthesis tiles, and reconstructed tiles;

FIG. 22 illustrates entropy tiles, the synthesis tiles and the reconstructed tiles in a regular case;

FIG. 23 illustrates entropy tiles, the synthesis tiles and the reconstructed tiles in a special case;

FIG. 24a illustrates a tile grid used for tile synthesis;

FIG. 24b illustrates a tile grid used for reading from and writing to the bitstream;

FIG. 25 illustrates the inputs to and outputs from a context model in the decoder;

FIG. 26 illustrates the tiles input to and output from the context model in the decoder;

FIG. 27 illustrates the tiles used during the decoding process using a context model;

FIG. 28 illustrates exemplary dimensions of the inputs to and output from the context model in the decoder;

FIG. 29 illustrates a pipe-line procedure including context determination for each tile;

FIG. 30 illustrates the tiles used during the encoding process using a context model;

FIG. 31 illustrates a decoding procedure;

FIG. 32 is a schematic block diagram of an electronic device according to some embodiments of the present application. The device may be used for processing by a neural network based unit;

FIG. 33 is a schematic block diagram of an electronic device according to some embodiments of the present application. The device may be used for processing by a neural network based unit;

FIG. 34 is a schematic block diagram of an electronic device according to some embodiments of the present application;

FIG. 35 is a flow diagram illustrating an exemplary method for decoding;

FIG. 36 is a flow diagram illustrating an exemplary method for encoding;

FIG. 37 shows a bitstream structure;

FIG. 38 is a block diagram showing an example of a video coding system configured to implement embodiments of the present disclosure;

FIG. 39 is a block diagram showing another example of a video coding system configured to implement embodiments of the present disclosure;

FIG. 40 is a block diagram illustrating an example of an encoding apparatus or a decoding apparatus;

FIG. 41 is a block diagram illustrating another example of an encoding apparatus or a decoding apparatus;

FIG. 42 is a block diagram illustrating another example of an encoding apparatus or a decoding apparatus;

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

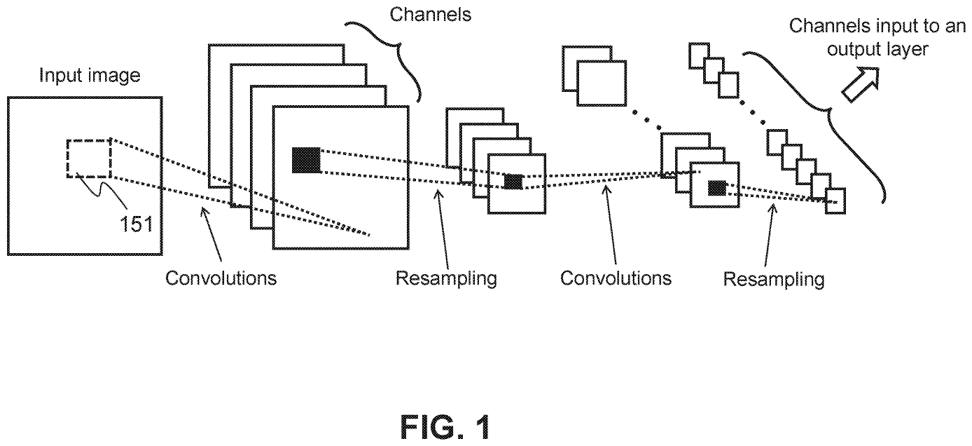

FIG. 1 schematically illustrates a general concept of processing by a neural network such as the CNN. A convolutional neural network consists of an input and an output layer, as well as multiple hidden layers. Input layer is the layer to which the input (such as a portion 151 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is usually a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favour compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function:

$$LeakyReLU ( x ) = max ( 0 , x ) + negative\_slope * min ( 0 , x ) , or$$

$$LeakyReLU ( x ) = \{ \begin{matrix}x , & if x \geq 0 \\ negative\_slope * x , & otherwise\end{matrix}$$

Among them, parameters:
negative_slope—Controls the angle of the negative slope. Default: 1e-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer.

### Autoencoders and Unsupervised Learning

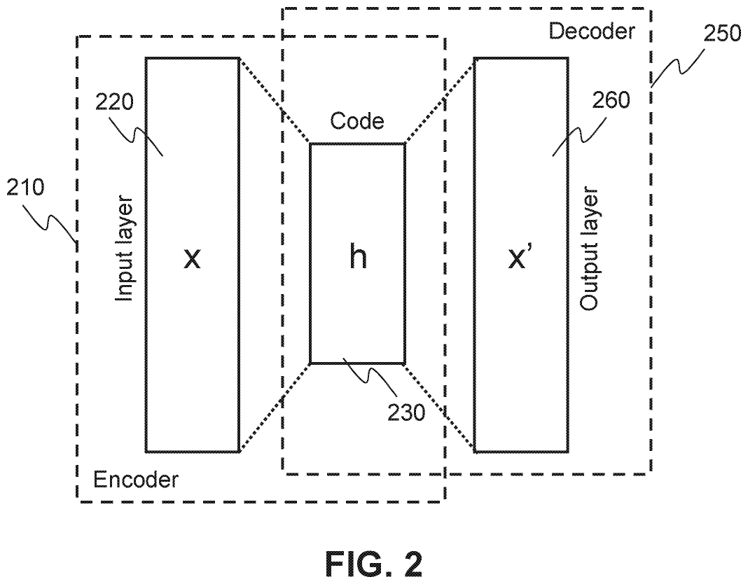

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( Wx + b ) .$$

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{φ}(h|x) to the posterior distribution p_{θ}(h|x) where φ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{KL} ( {q}_{ϕ} ( h \vert x ) \vert \vert {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0,I). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I )$$

where ρ(x) and ω²(x) are the encoder output, while μ(h) and σ²(h) are the decoder outputs. Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

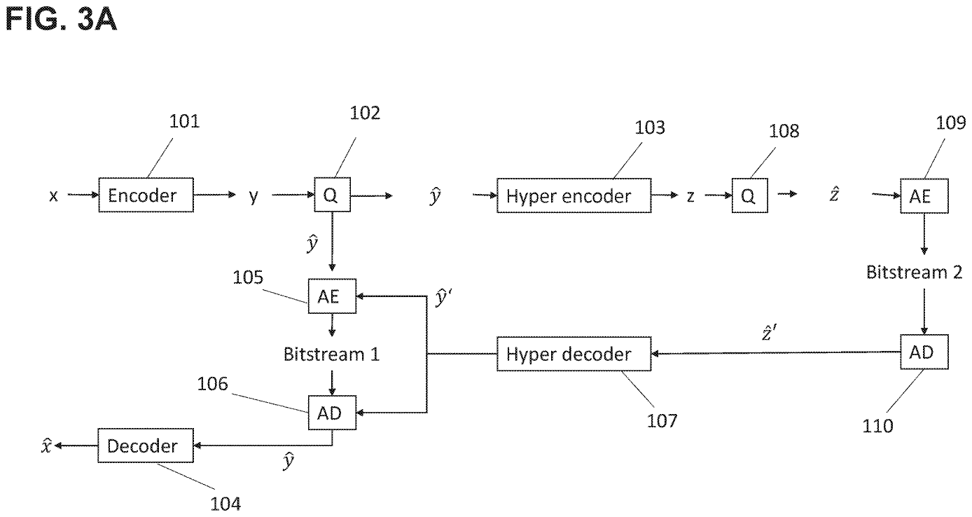

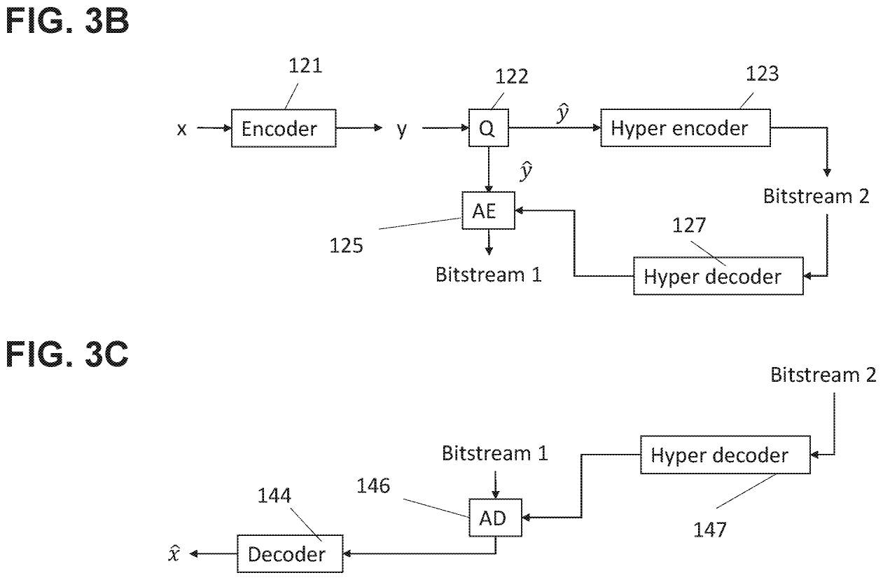

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f (x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(f). The signal z is the estimation of the input image x. It is desirable that x is as close to z as possible, in other words the reconstruction quality is as high as possible. However, the higher the similarity between z and x, the higher the amount of side information necessary to be transmitted. The side information includes bitstream1 and bitstream2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3A comprises modules 103, 108, 109, 110 and 107 and is called “hyper encoder/decoder” subnetwork. The second subnetwork is responsible for generating the second bitstream “bitstream2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (x) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and \hat{z}, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It is noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream1. The bitstream1 and bitstream2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf. for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

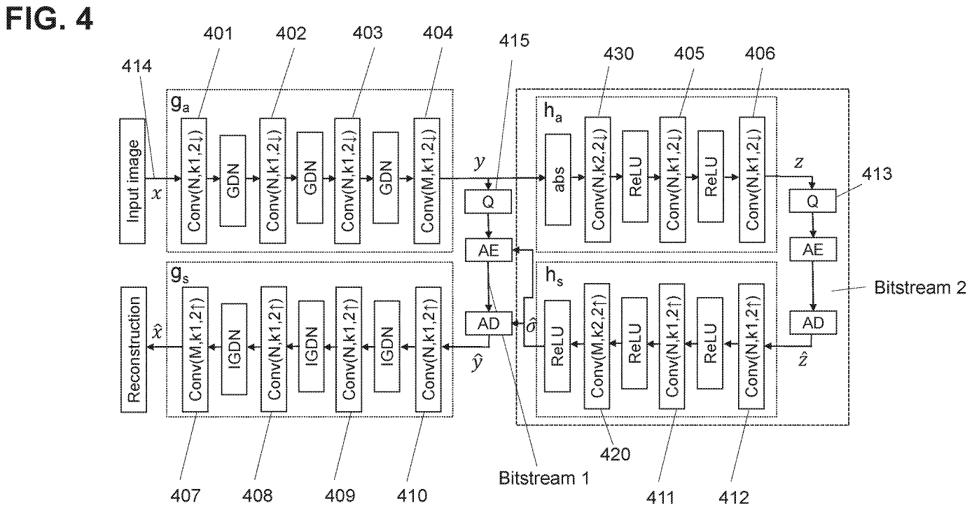

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover y as well. It then feeds ŷ into gₛ to obtain the reconstructed image.

The layers that include downsampling is indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ }413 is has width and height equal to w/64 and h/64 respectively. Modules denoted by AE and AD are arithmetic encoder and arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

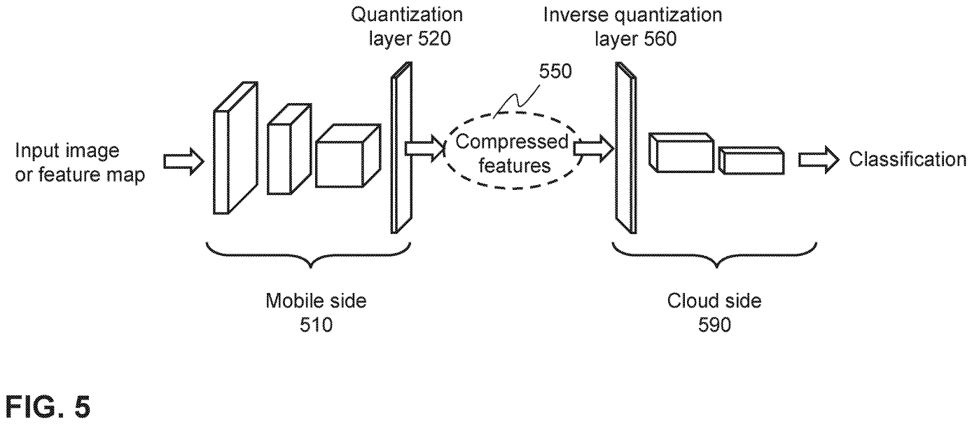

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, authors proposed the end-to-end deep video compression (DVC) model that jointly learns motion estimation, motion compression, and residual coding.

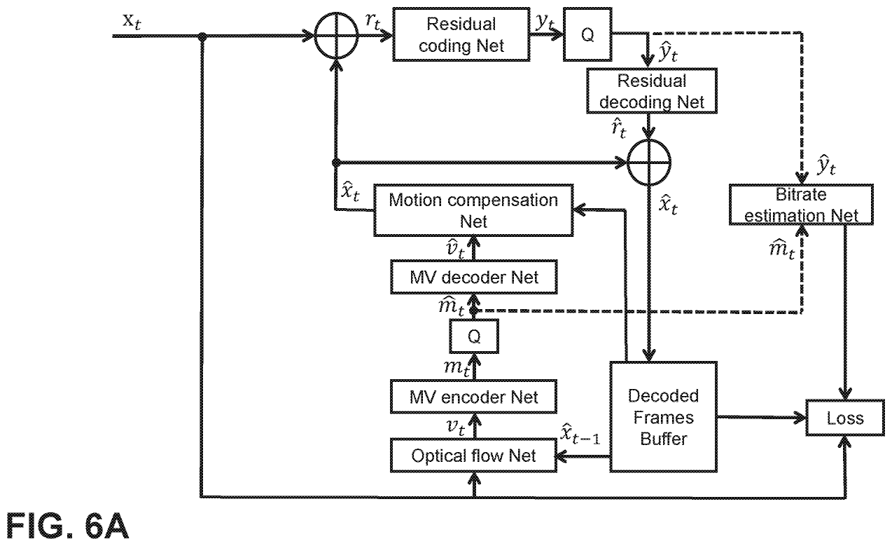

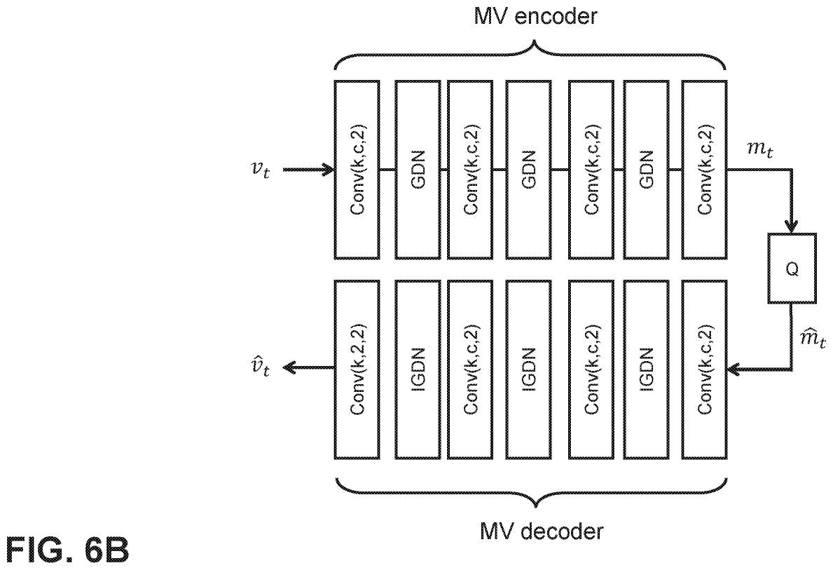

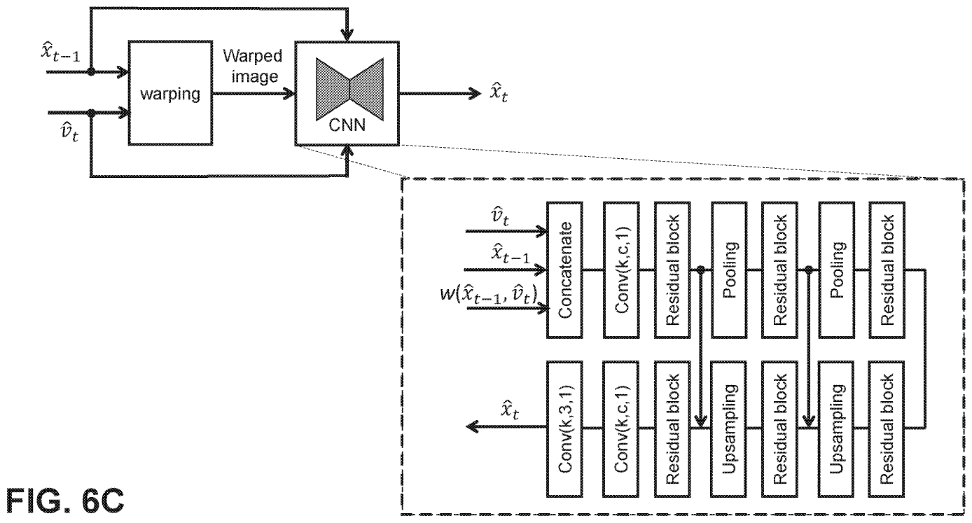

Such encoder is illustrated in FIG. 6A. In particular, FIG. 6A shows an overall structure of end-to-end trainable video compression framework. In order to compress motion information, a CNN was designated to transform the optical flow vt to the corresponding representations mₜ suitable for better compression. Specifically, an auto-encoder style network is used to compress the optical flow. The motion vectors (MV) compression network is shown in FIG. 6B. The network architecture is somewhat similar to the ga/gs of FIG. 4. In particular, the optical flow vt is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mₜ with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Said about disadvantages of state-of-the art autoencoder based approach to compression are also valid for machine vision tasks.

### Functional Modules

### Variable Bitrate Module

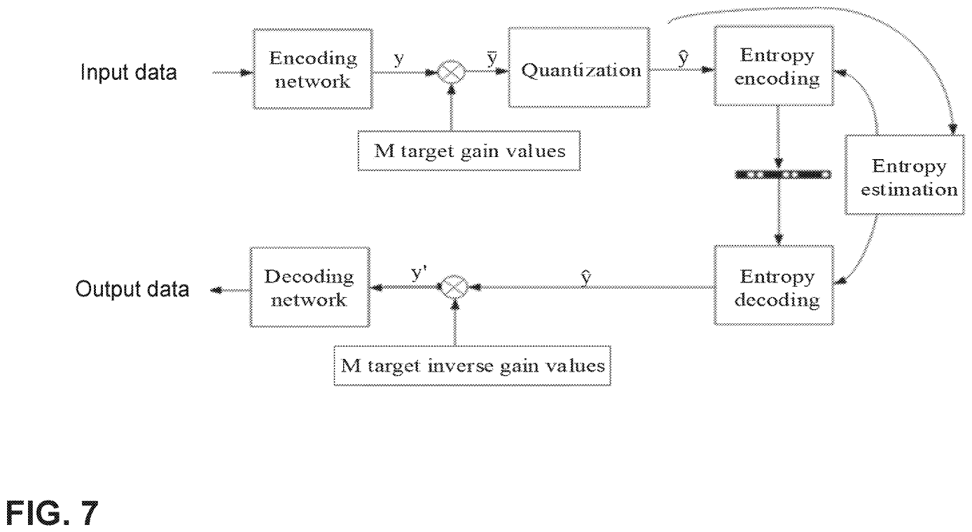

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value), as shown in FIG. 7. The scaling factor may be preset. Different quality levels or quantization parameters correspond to different target gain values. If the output of the encoding network is scaled to a smaller value, a bitstream size may be decreased. Otherwise, the bitstream size may be increased.

### Color Format Transform

RGB and YUV are common color spaces. Conversion between RGB and YUV may be performed according to an equation specified in standards such as CCIR 601 and BT.709.

### Separate Structure for Luma and Chroma

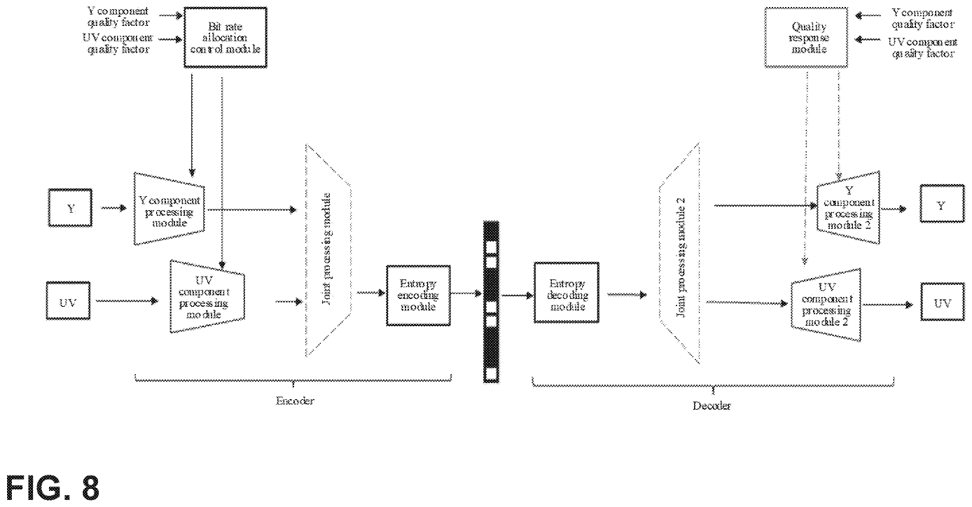

Some VAE-based codecs use the YUV color space as an input of an encoder and an output of a decoder, as shown in FIG. 8. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a color-sensitive image, a feature map of a UV component may be less quantized, and a quantity of bitstream bits for a UV component may be increased, to improve reconstruction quality of the UV component and achieve better visual effect.

In some other methods, an encoder concatenates (concatenate) a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

In the present specification, a ‘parameter’ is a value used in an operation process of each layer forming a neural network, and for example, may include a weight used when an input value is applied to a certain operation expression. Here, the parameter may be expressed in a matrix form. The parameter is a value set as a result of training, and may be updated through separate training data when necessary.

The following terms may also be defined as follows:

Picture size refers to the width w or height h or the width-height pair of a picture. Width and height of an image is usually measured in number of luma samples.

Downsampling, as mentioned above, is a process, where the sampling rate (sampling interval) of the discrete input signal is reduced. For example if the input signal is an image which has a size of h and w, and the output of the downsampling has a size of h2 and w2, at least one of the following holds true: h2<h, w2<w. In one example implementation, downsampling can be implemented as keeping only each m-th sample, discarding the rest of the input signal (e.g. image).

Upsampling is a process, where the sampling rate (sampling interval) of the discrete input signal is increased. For example if the input image has a size of h and w, and the output of the upsampling has a size h2 and w2, at least one of the following holds true: h<h2, w<w2.

Downsampling and upsampling processes are both examples of resampling. Resampling is a process where the sampling rate (sampling interval) of the input signal is changed.

During the upsampling or downsampling processes, filtering can be applied to improve the accuracy of the resampled signal and to reduce the aliasing affect. Interpolation filtering usually includes a weighted combination of sample values at sample positions around the resampling position. It can be implemented as:

$$f ( {x}_{r} , {y}_{r} ) = \sum s ( x , y ) C ( k )$$

where f( ) is the resampled signal, (xᵣ,yᵣ) are the resampling coordinates, C(k) are interpolation filter coefficients and s(x,y) are the input signal. The summation operation is performed for (x,y) that are in the vicinity of (xᵣ,yᵣ).

Trimming off the outside edges of a digital image can be referred to as cropping. Cropping can be used to make an image smaller (in number of samples) and/or to change the aspect ration (length to width) of the image.

Padding refers to increasing the size of the input (i.e. an input image) by generating new samples at the borders of the image by either using sample values that are predefined or by using sample values of the positions in the input image. The generated samples are approximations of non-existing actual sample values.

Resizing is a general term where the size of the input image is changed. It might be done using one of the methods of padding or cropping, or alternatively it can be done by resampling.

Integer division is division in which the fractional part (remainder) is discarded.

Convolution is given by the following general equation. Below f(can be defined as the input signal and go can be defined as the filter.

$$( f * g ) [ n ] = {\sum }_{m = - ∞}^{∞} f [ m ] g [ n - m ]$$

A downsampling layer is a layer of a neural network that results in reduction of at least one of the dimensions of the input. In general the input might have 3 or more dimensions, where the dimensions might comprise number of channels, width and height. The downsampling layer usually refers to reduction of the width and/or height dimensions. It can be implemented using convolution, averaging, max-pooling etc operations.

Feature maps are generated by applying Filters or Feature detectors to the input image or the feature map output of the prior layers. Feature map visualization will provide insight into the internal representations for specific input for each of the Convolutional layers in the model.

The latent space is the feature map generated by a neural network in the bottleneck layer.

An upsampling layer is a layer of a neural network than results in increase of at least one of the dimensions of the input. In general the input might have 3 or more dimensions, where the dimensions might comprise number of channels, width and height. The upsampling layer usually refers to increase in the width and/or height dimensions. It can be implemented with de-convolution, replication etc operations.

In a neural network context, the receptive field is defined as the size of the region in the input that produces the feature. Basically, it is a measure of association of an output feature (of any layer) to the input region (patch). It is important to note that the idea of receptive fields applies to local operations (i.e. convolution, pooling). For example a convolution operation with a kernel of size 3×3 has a receptive field of 3×3 samples in the input layer (9 input samples are used to obtain 1 output sample by the convolution node). The total receptive field is the set of input samples that are used to obtain a specified set of output samples by application of one or more processing layers.

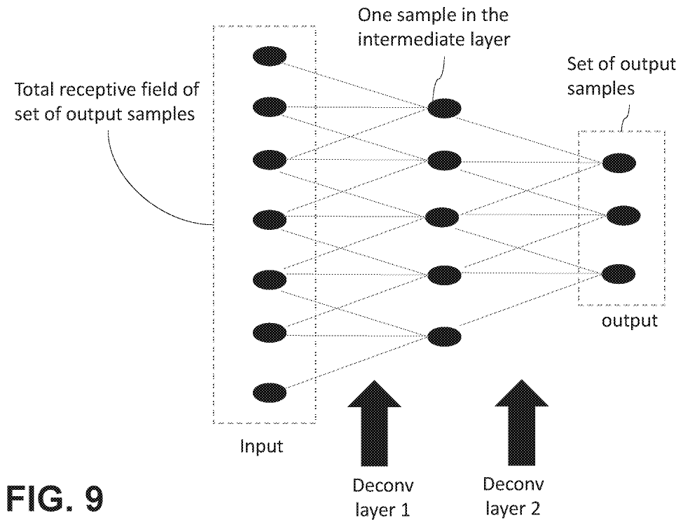

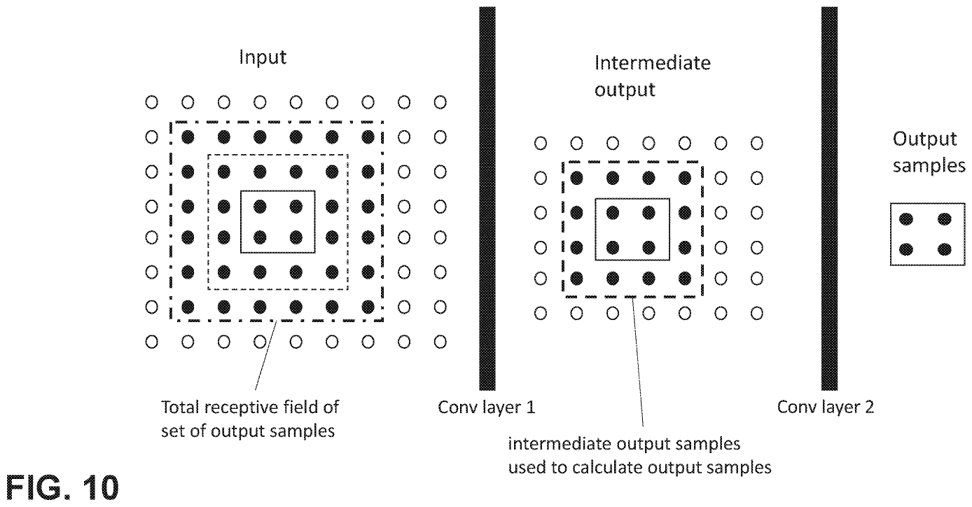

The total receptive field can be exemplified by FIGS. 9 and 10. In FIG. 9 processing of a one dimensional input (the 7 samples on the left of the figure) with 2 consecutive transposed convolution (also called as deconvolution) layers are exemplified. The input is processed from left to right, i.e. “deconv layer 1” processes the input first, whose output is processed by “deconv layer 2”. In the example the kernels have a size of 3 in both deconvolution layers. This means that 3 input samples are necessary to obtain 1 output sample at each layer. In the example the set of output samples are marked inside a dashed rectangle and comprise 3 samples. Due to the size of the deconvolution kernel, 7 samples are necessary at the input to obtain the output set of samples comprising 3 output samples. Therefore the total receptive field of the marked 3 output samples are the 7 samples at the input. In FIG. 9, there are 7 input samples, 5 intermediate output samples and 3 output samples. The reduction in the number of samples is due to the fact that, since the input signal is finite (not extending to the infinity in each direction), at the borders of the input there are “missing samples”. In other words, since a deconvolution operation requires 3 input samples corresponding to each output sample, only 5 intermediate output samples can be generated if the number of input samples are 7. In fact the amount of output samples that can be generated is (k−1) samples less than number of input samples, where k is the kernel size. Since in FIG. 9 the number of input samples are 7, after the first deconvolution with kernel size 3, the number of intermediate samples is 5. After the second deconvolution with kernel size 3, the number of output samples is 3.

It is sometimes desirable to keep the number of samples same after each operation (convolution or deconvolution or other). In such a case one can apply padding at the boundaries of the input to compensate for “missing samples”. It is noted that the invention is applicable to both cases, as padding is not a mandatory operation for convolution, deconvolution or any other processing layer.

This is not to be confused with downsampling. In the process of downsampling, for every M samples there are N samples at the output and N<M. And the key difference is, M is usually much smaller than the number of inputs. In FIG. 9, there is no downsampling, the reduction in number of samples result from the fact that the size of the input is not infinite and there are “missing samples” at the input. For example if the number of input samples were 100, since the kernel size is k=3, the number of output samples would have been 100−(k−1)−(k−1)=96. If both deconvolution layers had downsampling (with ration of M=2 and N=1), then the number of output samples would have been

$$ceil ( \frac{ceil ( \frac{( 100 - ( k - 1 ) )}{2} ) - ( k - 1 )}{2} ) = 22.$$

The operation of convolution and deconvolution (a.k.a transposed convolution) are from the mathematical expression point of view identical. The difference stems from the fact that the deconvolution operation assumes that a previous convolution operation took place. In other words, deconvolution is the process of filtering a signal to compensate for an undesired convolution. The goal of deconvolution is to recreate the signal as it existed before the convolution took place. Embodiments of the present invention can be applied to both convolution and deconvolution operations (and in fact any other operation where the kernel size is greater than 1.

As can be observed in FIG. 9, the total receptive field of the 3 output samples are 7 samples at the input. The size of the total receptive field increases by successive application of processing layers with kernel size greater than 1. In general the total receptive field of a set of output samples are calculated by tracing the connections of each node starting from the output layer till the input layer, and then finding the union of all of the samples in the input that are directly or indirectly (via more than 1 processing layer) connected to the set of output samples. In FIG. 9 for example each output sample is connected to 3 samples in a previous layer. The union set includes 5 samples in the intermediate output layer, which are connected to 7 samples in the input layer.

Another example to explain how to calculate the total receptive field is presented in FIG. 10. In FIG. 10. a two dimensional input sample array is processed by 2 convolution layers with kernel sizes of 3×3 each. After the application of the 2 deconvolution layers the output array is obtained. The set (array) of output samples are marked with dashed rectangle (“set of output samples”) and comprise 2×2=4 samples. The total receptive field of the “set of output samples” comprises 6×6=36 samples. The total receptive field can be calculated as:
each output sample is connected to 3×3 samples in the intermediate output. The union of all of the samples in the intermediate output that are connected to the set of output samples comprises 4×4=16 samples.
each of the 16 samples in the intermediate output are connected to 3×3 samples in the input. The union of all of the samples in the input that are connected to the 16 samples in the intermediate output comprises 6×6=36 samples. Accordingly the total receptive field of the 2×2 output samples is 36 samples at the input.

A neural network may comprise multiple sub-networks. Sub-networks have 1 or more layers. Different sub-networks have different input/output size and so different memory requirement/computational complexity.

A pipeline is a series of subnetworks which process a particular component of an image. An example could be a system with two pipelines, where the first pipeline only processes the luma component and the second pipeline processes the chroma component(s). One pipeline processes only one component, but it can use a second component as auxiliary information to aid the processing. For example, the pipeline which has the chroma component as output can have the latent representation of both luma and chroma components as input (conditional coding of chroma component).

Conditional color separation (CCS) is a NN architecture for images/video coding/processing in which primary color component is coded/processed independently, but secondary color components are coded/processed conditionally, using primary component as auxiliary input.

Exemplary methods and devices according to particular embodiments of the present disclosure will now be described in further detail. The following describes the technical solutions in the present application with reference to the accompanying drawings.

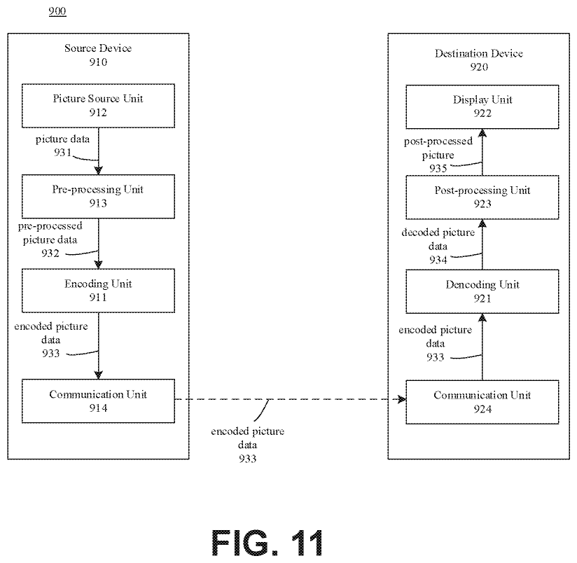

FIG. 11 is a schematic block diagram illustrating a coding system according to some embodiments of the present application. Referring to FIG. 11, the coding system 900 includes a source device 910 configured to provide encoded picture data to a destination device 920 for decoding the encoded picture data. For convenience, it is assumed that the coding system 900 is a picture coding system. As will be apparent for the skilled person, the picture coding system is just example embodiments of the invention and embodiments of the invention are not limited thereto.

The source device 910 may include an encoding unit 911. Optionally, the source device 910 may further include a picture source unit 912, a pre-processing unit 913, and a communication unit 914.

The picture source unit 912 may include or be any kind of picture capturing device, for example for capturing a rea-word picture, and/or any kind of a picture generating device, for example a computer-graphics processor for generating a computer animated picture, or any kind of device for obtaining and/or providing a real-word picture, a computer animated picture (e.g., a screen content, a virtual reality (VR) picture) and/or any combination thereof (e.g., an augmented reality (AR) picture). In the following, all these kinds of pictures and any other kind of picture will be referred to as “picture”.

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance/chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array.

The picture source unit 912 may be, for example a camera for capturing a picture, a memory, e.g. a picture memory, comprising or storing a previously captured or generated picture, and/or any kind of interface (internal or external) to obtain or receive a picture. The camera may be, for example, a local or integrated camera integrated in the source device, the memory may be a local or integrated memory, e.g. integrated in the source device. The interface may be, for example, an external interface to receive a picture from an external video source, for example an external picture capturing device like a camera, an external memory, or an external picture generating device, for example an external computer-graphics processor, computer or server. The interface can be any kind of interface, e.g. a wired or wireless interface, an optical interface, according to any proprietary or standardized interface protocol. The interface for obtaining the picture data 931 may be the same interface as or a part of the communication unit 914.

In distinction to the pre-processing unit 913 and the processing performed by the pre-processing unit 913, the picture or picture data 931 may also be referred to as raw picture or raw picture data 931.

The pre-processing unit 913 is configured to receive the (raw) picture data 931 and to perform pre processing on the picture data 931 to obtain a pre-processed picture 932 or pre-processed picture data.

The pre-processing performed by the pre-processing unit 913 may, e.g., comprise trimming, color format conversion (e.g. from RGB to YCbCr), color correction, or de-noising. The encoding unit 911 is configured to receive the pre-processed picture data 932 and provide encoded picture data 933.

The communication unit 914 of the source device 910 may be configured to receive the encoded picture data 933 and to directly transmit it to another device, e.g. the destination device 920 or any other device, for storage or direct reconstruction, or to process the encoded picture data 933 for respectively before storing the encoded picture data 933 and/or transmitting the encoded picture data 933 to another device, e.g. the destination device 920 or any other device for decoding or storing.

The destination device 920 comprises a decoding unit 921, and may additionally, i.e. optionally, comprise a communication unit 924, a post-processing unit 923 and a display unit 922.

The communication unit 924 of the destination device 920 is configured receive the encoded picture data 933, e.g. directly from the source device 910 or from any other source, e.g. a memory, e.g. an encoded picture data memory.

The communication unit 914 and the communication unit 924 may be configured to transmit respectively receive the encoded picture data 933 via a direct communication link between the source device 910 and the destination device 920, e.g. a direct wired or wireless connection, or via any kind of network, e.g. a wired or wireless network or any combination thereof, or any kind of private and public network, or any kind of combination thereof.

The communication unit 914 may be, e.g., configured to package the encoded picture data 933 into an appropriate format, e.g. packets, for transmission over a communication link or communication network, and may further comprise data loss protection and data loss recovery.

The communication unit 924, forming the counterpart of the communication unit 914, may be, e.g., configured to de-package the packets to obtain the encoded picture data 933 and may further be configured to perform data loss protection and data loss recovery, e.g. comprising error concealment.

Both, the communication unit 914 and the communication unit 924 may be configured as unidirectional communication interfaces as indicated by the arrow for the encoded picture data 933 in FIG. 11 pointing from the source device 910 to the destination device 920, or bi-directional.

The communication units, and may be configured, e.g. to send and receive messages, e.g. to set up a connection, to acknowledge and/or re-send lost or delayed data including picture data, and exchange any other information related to the communication link and/or data transmission, e.g. encoded picture data transmission.

The decoder 921 is configured to receive the encoded picture data 933 and provide decoded picture data 934.

The post-processing unit 923 of destination device 920 is configured to post-process the decoded picture data 934 to obtain post-processed picture data 935. The post-processing performed by the post-processing unit 923 may comprise, e.g. color format conversion (e.g. from YCbCr to RGB), color correction, trimming, or re-sampling, or any other processing, e.g. for preparing the decoded picture data 934 for display, e.g. by display unit 922.

The display unit 922 of the destination device 920 is configured to receive the post-processed picture data 935 for displaying the picture, e.g. to a user or viewer. The display unit 922 may be or comprise any kind of display for representing the reconstructed picture, e.g. an integrated or external display or monitor. The displays may, e.g. comprise cathode ray tubes (CRT), liquid crystal displays (LCD), plasma displays, organic light emitting diodes (OLED) displays or any kind of other display, such as beamer, hologram (3D), or the like.

Although FIG. 11 depicts the source device 910 and the destination device 920 as separate devices, embodiments of devices may also comprise both or both functionalities, the source device 110 or corresponding functionality and the destination device 920 or corresponding functionality. In such embodiments the source device 910 or corresponding functionality and the destination device 920 or corresponding functionality may be implemented using the same hardware and/or software or by separate hardware and/or software or any combination thereof.

As will be apparent for the skilled person based on the description, the existence and (exact) split of functionalities of the different units or functionalities within the source device 910 and/or destination device 920 as shown in FIG. 11 may vary depending on the actual device and application.

Therefore, the source device 910 and the destination device 920 as shown in FIG. 11 are just example embodiments of the invention and embodiments of the invention are not limited to those shown in FIG. 11.

The source device 910 and the destination device 920 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices, broadcast receiver device, or the like and may use no or any kind of operating system.

The embodiments of this application relate to application of a large quantity of neural networks. Therefore, for ease of understanding, related terms and related concepts such as the neural network in the embodiments of this application are first described below.

### (1) Neural Network

The neural network may include neurons. The neuron may be an operation unit that uses xs and an intercept 1 as inputs, and an output of the operation unit may be as follows:

$${h}_{W , b} ( x ) = f ( {W}^{T} x ) = f ( {\sum }_{s = 1}^{n} {W}_{s} {x}_{s} + b )$$

Herein, s=1, 2, . . . , or n, n is a natural number greater than 1, Ws is a weight of xs, and b is bias of the neuron. f is an activation function of the neuron, and the activation function is used to introduce a non-linear feature into the neural network, to convert an input signal in the neuron into an output signal. The output signal of the activation function may be used as an input of a next convolutional layer. The activation function may be a sigmoid function. The neural network is a network formed by connecting many single neurons together. To be specific, an output of a neuron may be an input of another neuron. An input of each neuron may be connected to a local receptive field of a previous layer to extract a feature of the local receptive field. The local receptive field may be a region including several neurons.

### (2) Deep Neural Network

The deep neural network (DNN), also referred to as a multi-layer neural network, may be understood as a neural network having many hidden layers. The “many” herein does not have a special measurement standard. The DNN is divided based on locations of different layers, and a neural network in the DNN may be divided into three types: an input layer, a hidden layer, and an output layer. Generally, the first layer is the input layer, the last layer is the output layer, and the middle layer is the hidden layer. Layers are fully connected. To be specific, any neuron at the ith layer is certainly connected to any neuron at the (i+1)th layer. Although the DNN looks to be complex, the DNN is actually not complex in terms of work at each layer, and is simply expressed as the following linear relationship expression: ŷ=α(W\vec{x}+\vec{b}), where \vec{x} is an input vector, \vec{y} is an output vector, \vec{b} is a bias vector, W is a weight matrix (also referred to as a coefficient), and α( ) is an activation function. At each layer, the output vector \vec{y} is obtained by performing such a simple operation on the input vector \vec{x}. Because there are many layers in the DNN, there are also many coefficients W and bias vectors \vec{b}. Definitions of these parameters in the DNN are as follows: The coefficient W is used as an example. It is assumed that in a DNN having three layers, a linear coefficient from the fourth neuron at the second layer to the second neuron at the third layer is defined as

$${w}_{24}^{3} .$$

The superscript 3 represents a layer at which the coefficient W is located, and the subscript corresponds to an output third-layer index 2 and an input second-layer index 4. In conclusion, a coefficient from the k^{th} neuron at the (L−1)^{th} layer to the j^{th} neuron at the L^{th} layer is defined as

$${W}_{jk}^{L} .$$

It should be noted that there is no parameter W at the input layer. In the deep neural network, more hidden layers make the network more capable of describing a complex case in the real world.

Theoretically, a model with a larger quantity of parameters indicates higher complexity and a larger “capacity”, and indicates that the model can complete a more complex learning task. Training the deep neural network is a process of learning a weight matrix, and a final objective of the training is to obtain a weight matrix of all layers of the trained deep neural network (a weight matrix including vectors W at many layers).

### (3) Convolutional Neural Network

The convolutional neural network (CNN is a deep neural network having a convolutional structure. The convolutional neural network includes a feature extractor including a convolutional layer and a sub sampling layer. The feature extractor may be considered as a filter. A convolution process may be considered as using a trainable filter to perform convolution on an input image or a convolutional feature plane (feature map). The convolutional layer is a neuron layer that is in the convolutional neural network and at which convolution processing is performed on an input signal. At the convolutional layer of the convolutional neural network, one neuron may be connected only to some adjacent-layer neurons. A convolutional layer usually includes a plurality of feature planes, and each feature plane may include some neurons arranged in a rectangular form. Neurons in a same feature plane share a weight. The shared weight herein is a convolution kernel. Weight sharing may be understood as that an image information extraction manner is irrelevant to a location. A principle implied herein is that statistical information of a part of an image is the same as that of another part. This means that image information learned in a part can also be used in another part. Therefore, image information obtained through same learning can be used for all locations in the image. At a same convolutional layer, a plurality of convolution kernels may be used to extract different image information. Usually, a larger quantity of convolution kernels indicates richer image information reflected by a convolution operation.

The convolution kernel may be initialized in a form of a random-size matrix. In a process of training the convolutional neural network, the convolution kernel may obtain an appropriate weight through learning. In addition, a direct benefit brought by weight sharing is that connections between layers of the convolutional neural network are reduced and an overfitting risk is lowered.

### (4) Recurrent Neural Network

A recurrent neural network (RNN) is used to process sequence data. In a conventional neural network model, from an input layer to a hidden layer and then to an output layer, the layers are fully connected, and nodes at each layer are not connected. Such a common neural network resolves many difficult problems, but is still incapable of resolving many other problems. For example, if a word in a sentence is to be predicted, a previous word usually needs to be used, because adjacent words in the sentence are not independent. A reason why the RNN is referred to as the recurrent neural network is that a current output of a sequence is also related to a previous output of the sequence. A specific representation form is that the network memorizes previous information and applies the previous information to calculation of the current output. To be specific, nodes at the hidden layer are connected, and an input of the hidden layer not only includes an output of the input layer, but also includes an output of the hidden layer at a previous moment. Theoretically, the RNN can process sequence data of any length. Training for the RNN is the same as training for a conventional CNN or DNN. An error back propagation algorithm is also used, but there is a difference: If the RNN is expanded, a parameter such as W of the RNN is shared. This is different from the conventional neural network described in the foregoing example. In addition, during use of a gradient descent algorithm, an output in each step depends not only on a network in the current step, but also on a network status in several previous steps. The learning algorithm is referred to as a back propagation through time (BPTT) algorithm.

Now that there is a convolutional neural network, why is the recurrent neural network required? A reason is simple. In the convolutional neural network, it is assumed that elements are independent of each other, and an input and an output are also independent, such as a cat and a dog. However, in the real world, many elements are interconnected. For example, stocks change with time. For another example, a person says: I like traveling, and my favorite place is Yunnan. I will go if there is a chance. If there is bank filling, people should know that “Yunnan” will be filled in the blank. A reason is that the people can deduce the answer based on content of the context. However, how can a machine do this? The RNN emerges. The RNN is intended to make the machine capable of memorizing like a human. Therefore, an output of the RNN needs to depend on current input information and historical memorized information.

### (5) Loss Function

In a process of training the deep neural network, because it is expected that an output of the deep neural network is as much as possible close to a predicted value that is actually expected, a predicted value of a current network and a target value that is actually expected may be compared, and then a weight vector of each layer of the neural network is updated based on a difference between the predicted value and the target value (certainly, there is usually an initialization process before the first update, to be specific, parameters are preconfigured for all layers of the deep neural network). For example, if the predicted value of the network is large, the weight vector is adjusted to decrease the predicted value, and adjustment is continuously performed until the deep neural network can predict the target value that is actually expected or a value that is very close to the target value that is actually expected. Therefore, “how to obtain, through comparison, a difference between a predicted value and a target value” needs to be predefined. This is the loss function (loss function) or an objective function (objective function). The loss function and the objective function are important equations used to measure the difference between the predicted value and the target value. The loss function is used as an example. A higher output value (loss) of the loss function indicates a larger difference. Therefore, training of the deep neural network is a process of minimizing the loss as much as possible.

### (6) Back Propagation Algorithm

The convolutional neural network may correct a value of a parameter in an initial super-resolution model in a training process according to an error back propagation (BP) algorithm, so that an error loss of reconstructing the super-resolution model becomes smaller. Specifically, an input signal is transferred forward until an error loss occurs at an output, and the parameter in the initial super-resolution model is updated based on back propagation error loss information, to make the error loss converge. The back propagation algorithm is an error-loss-centered back propagation motion intended to obtain a parameter, such as a weight matrix, of an optimal super-resolution model.

Variational Autoencoder (VAE) is a generative model that combines the ideas of an autoencoder and probabilistic graphical models to learn the underlying distribution of input data. In VAE, it is assumed that the input data x is generated by a latent variable y. In the encoder, the input data x is mapped to the distribution of the latent variable y.

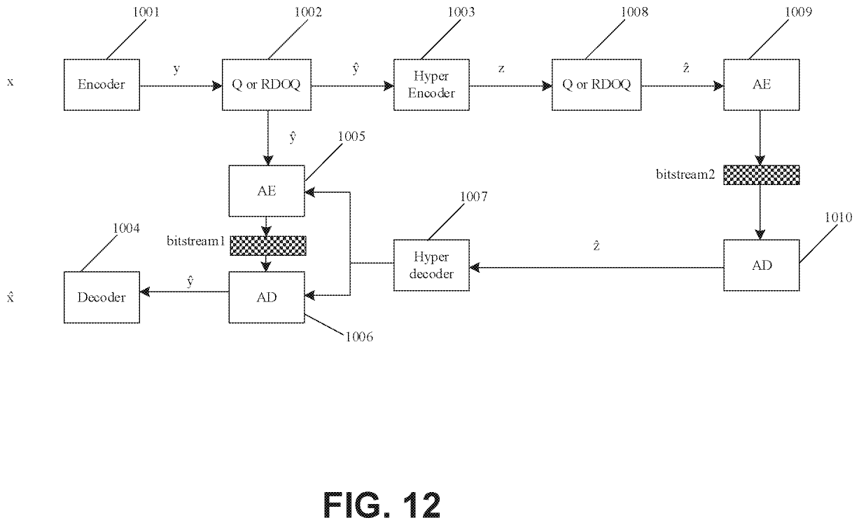

FIG. 12 exemplifies the VAE framework. In the figure the encoder 1001 maps an image x into a latent representation via the function y=f (x). The quantizer 1002 that transforms the latent representation into the discrete values, ŷ=Q(y); The entropy model, or the hyper encoder/decoder (also known as hyperprior) 1003 estimates the distribution of y to get the minimum rate achievable with lossless entropy source coding; and the y and the side information \hat{z} of the hyperprior are included in a bitstream using arithmetic coding (And the decoder that transforms the quantized latent representation to the image, \hat{x}=g(ŷt).

Although input data of FIG. 12 is an image, the present application is not restricted to image or video compression, and can be applied to object detection, image generation, and recognition systems as well.

In FIG. 12, there are 2 sub networks concatenated to each other. The first network is composed of processing units 1001, 1002, 1004, 1005 and 1006. The units 1001, 1002, and 1005 are called the auto-encoder/decoder or simply the encoder/decoder network. The second subnetwork is composed of the units 1003 and 1007 and called the hyper encoder/decoder.

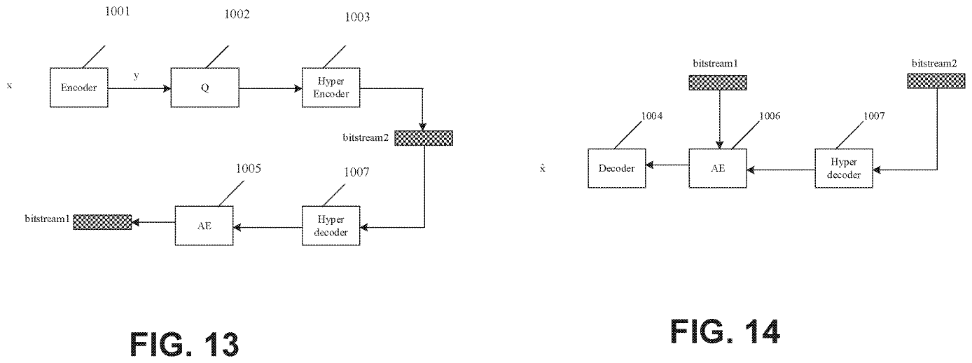

The FIG. 12 depicts the encoder and decoder in a single figure. FIG. 13 depicts the encoder and FIG. 14 depicts the decoder components of the VAE framework. The output of the encoder is bitstream 1 and bitstream 2, wherein bitstream 1 is the output of the first sub-network of the encoder and the bitstream 2 is the output of the second subnetwork of the encoder.

Similarly in FIG. 14, the 2 bitstreams are received as input and i, which is the reconstructed (decoded) image is generated at the output.

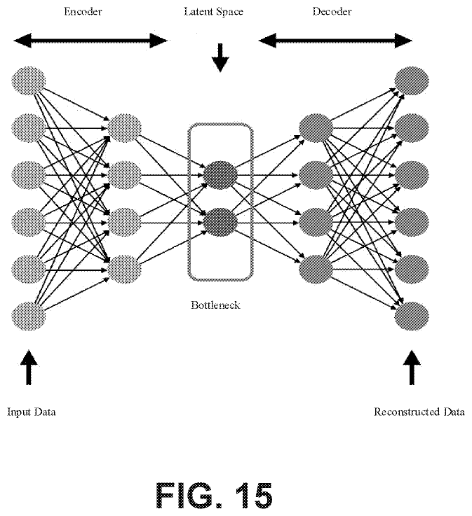

Majority of deep learning based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the dimension of the signal is reduced, and hence it is easier to compress the signal y. The general principle of compression is exemplified in FIG. 15. The latent space, which is the output of the encoder and input of the decoder, represents the compressed data. It is noted that the size of the latent space is much smaller than the input signal size.

The reduction in the size of the input signal is exemplified in the FIG. 15, which represents a deep learning based encoder and decoder. In the FIG. 15 the input image x corresponds to the input data, which is the input of the Encoder. The transformed signal y corresponds to the Latent Space, which has a smaller dimensionality than the input signal. Each column of circles represents a layer in the processing chain of the encoder or decoder. The number of circles in each layer indicate the size or the dimensionality of the signal at that layer.

One can see from the FIG. 15 that the encoding operation corresponds to reduction in the size of the input signal, whereas the decoding operation corresponds to reconstruction of the original size of the image.

Further, the encoding operation also depends on number of channels. For example, for luma input of encoder has 1 channel, latent space typically 128-160 channels. The number of elements (width times height times channels) is typically reduced by the encoding operation.

One of the methods for reduction of the signal size is down-sampling. Downsampling is a process where the sampling rate of the input signal is reduced. For example, if the input image has a size of h and w, and the output of the downsampling is h2 and w2, at least one of the following holds true:

$$h 2 < h$$

$$w 2 < w$$

The reduction in the signal size usually happens step by step along the chain of processing layers, not all at once. For example, if the input image x has dimensions of h and w (indicating the height and the width), and the latent space y has dimensions h/16 and w/16, the reduction of size might happen at 4 layers during the encoding, wherein each layer reduces the size of the signal by a factor of 2 in each dimension.

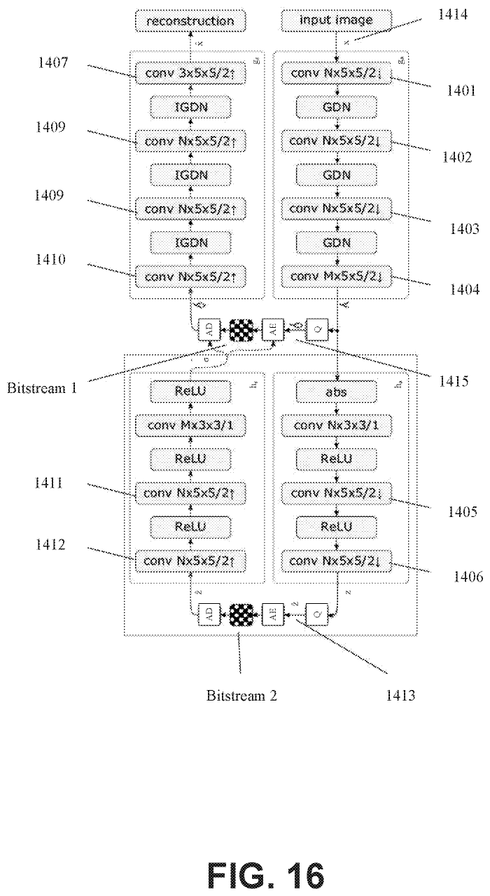

State of the art deep learning based video/image compression methods employs multiple downsampling layers. As an example, the VAE framework, FIG. 16, utilizes 6 downsampling layers that are marked 1401 to 1406. The layers that include downsampling is indicated with the downward arrow in the layer description. The layer description “Cony N×5×5/2↓” means that the layer is a convolution layer, with N channels and the convolution kernel is 5×5 in size. As stated, the 2↓ means that a downsampling with a factor of 2 is performed in this layer. Downsampling by a factor of 2 results in one of the dimensions of the input signal is reduced by half at the output. In FIG. 16, the 2↓ indicates that both width and height of the input image is reduced by a factor of 2. Since there are 6 downsampling layers, if the width and height of the input image x (1414) is given by w and h, the output signal \hat{z} (1413) is has width and height equal to w/64 and h/64 respectively.

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain \hat{σ}, which provides it with the correct probability estimates to successfully recover ŷ as well. It then feeds ŷ into gₛ to obtain the reconstructed image.

In FIG. 16, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 1412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 1407 to 1412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

The present application may be applicable both to end-2-end AI codecs and hybrid AI codecs. In hybrid AI codec for example the filtering operation (filtering of the reconstructed picture) can be performed by means of a neural network (NN). The present application applies to such NN based processing modules. In general, the present application may be applied to whole or part of a compression and decompression process, if at least part of the process includes NN and if such NN includes convolution or transposed convolution operations.

In image and video compression systems, compressing and decompressing of an input image that has a very large size is usually performed by division of the input image into multiple parts. VVC and HEVC employ such division methods, for example partitioning of input image into tiles or wavefront processing units.

When tiles are used in traditional video coding systems, an input image is usually divided into multiple parts of rectangular shape. The two parts can be processed independently of each other and the bitstreams for decoding of each part can be encapsulated into independently decodable units. As a result, the decoder can parse (i.e. obtain the syntax elements necessary for sample reconstruction) each bitstream (corresponding to part 1 and part 2) independently and can reconstruct the samples of each part independently.

The use of tiles can make it possible to perform whole or part of the decoding operation independently of each other. The benefit of independent processing is that multiple identical processing cores can be used to process the whole image. Hence the speed of processing can be increased. If the capability of a processing core is not enough to process a big image, the image can be split into multiple parts which require less resources for processing. In this case, a less capable processing unit can process each part, even if it cannot process the whole image due to resource limitation.

According to an encoding method provided by the present application, an input data is divided into several segments (hereinafter referred to as “input segment”). The several input segments may be processed separately. For example, the input segment may be processed by an encoding network. More than one identical encoding network may be used to process the input segments.

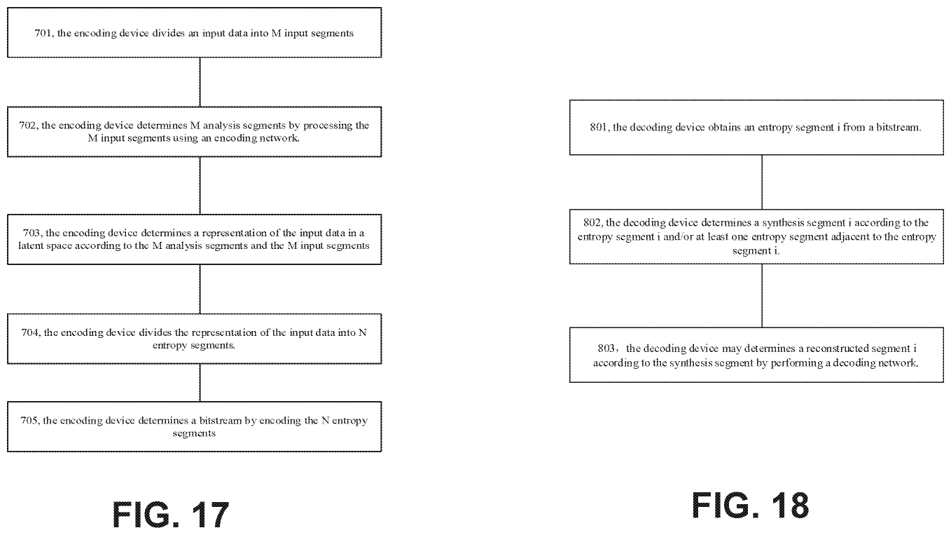

FIG. 17 illustrates a flowchart of an encoding method provided by some embodiments of the present application. In some embodiments, the method illustrated in FIG. 17 may be performed by an electronic device. The electronic device is used for encoding an input data. Therefore, in some embodiments, the electronic device may be referred to as an encoding device. In some other embodiments, the method illustrated in FIG. 17 may be performed by a component of the encoding device. For example, the method illustrated in FIG. 17 may be implemented by a processor, a chip, a system on chip (SoC) or a processing circuitry of the encoding device. For convenience, the method illustrated in FIG. 17 will be described as being performed by the encoding device.

701, the encoding device divides an input data into M input segments. M is a positive integer greater than one. Each of the M input segments has an overlap region with its adjacent input segments. For example, an input segment 1 is the first input segment among the M input segments, an input segment 2 is the second input segment among the M input segment, and an input segment 3 is a third input segment among the M input segments. In other word, the input segment 1 is adjacent to the input segment 2, and the input segment 2 is adjacent to both the input segment 1 and the input segment 3. The input segment 1 may include a region 1 and a region 2, the input segment 2 may include the region 2, a region 3 and a region 4, and the input segment 3 may include the region 4 and a region 5. For the input segment 1 and the input segment 2, the region 2 is the overlap region. For the input segment 2 and the input segment 3, the region 4 is the overlap region. Therefore, it may be described that the input segment 1 has one overlap region with its adjacent input segment (that is the input segment 2), the input segment 2 has two overlap regions with its adjacent input segments (that is the input segment 1 and the input segment 3), and the input segment 3 has one overlap region with its adjacent input segment (that is the input segment 2).

In some embodiments, a size of the input segments is fixed. In other words, any two input segments among the M input segments have the same size. In some other embodiments, the size of the input segments is not fixed. In other words, any two input segments among the M input segments may have different sizes.

Further, in some embodiments, the size of the input segments may be predetermined. In some other embodiments, the size of the input segments may be set by a user. In some other embodiments, the size of the input segments may be negotiated between the encoding device and a corresponding decoding device. In some other embodiments, the size of the input segments may be determined according to a preset rule. For example, the size of the input segments may be determined according to a size of the input data. The size of the input segments and the method for determining the size of the input segments are not limited thereto.

702, the encoding device determines M analysis segments by processing the M input segments using an encoding network.

For example, in some embodiments, the encoding network may include the encoder 1001 and the quantizer 1002 shown in FIG. 13. In some embodiments, the encoder 1001 may perform an analysis transform on each of the M input segments and output M transformed input segments. The quantizer 1002 may transform the obtained M transformed input segments into M sets of discrete values, where, the M sets of discrete values are the M analysis segments.

In some other embodiments, the encoding network may merely include the analysis transform operation. In other words, the encoding device may perform the analysis transform on the M input segments, and transformed results are the M analysis segments.

In some other embodiments, in addition to the encoder 1001 and the quantizer 1002, the encoding network may include one or more additional processing units. For example, one of the additional processing units is used to correct, remove, or add one or more component in one or more segments.

703, the encoding device determines a representation of the input data in a latent space according to the M analysis segments and the M input segments.

As previously mentioned, the encoding network may include the analysis transform operation, and the analysis transform operation may transform the input segments into the latent space. Therefore, M analysis segments may represent the M input segments in the latent space.

In some embodiments, the encoding device may determine M core segments according to the M analysis segments and the M input segments. A j^{th} core segments among the M core segments is determined according to a j^{th} analysis segments among the M analysis segments and a j^{th} input segment among the M input segments, j=1, . . . , M. Then, the encoding device may determine the representation of the input data by constitute the M core segments. Each of the M core segments has no overlap region with its adjacent core segments. In other words, the encoding device crops the analysis segments to obtain the core segments. Then, the encoding device concatenates the core segments to the representation.

704, the encoding device divides the representation of the input data into N entropy segments.

Each of the N entropy segments has no overlap region with its adjacent entropy segments. N is a positive integer greater than one.

In some embodiments, the encoding device may determine N shifted segments according to the M input segments, determines N shifted latent segments according to the N shifted segments and an alignment parameter of the analysis transform; determines the location information of the each of the N entropy segments according to the N shifted latent segments and the N shifted segments.

705, the encoding device determines a bitstream by encoding the N entropy segments.

In other words, the bitstream may be used to transmit the N entropy segments to the decoding device. The bitstream may further include a segment flag information. The segment flat information is used indicates that the bitstream comprises N entropy segments.

For example, a field of length 1 bit may be used to carry the segment flat information. If the value of this field is 1, the bitstream carries the N entropy segments. If the value of this field is 0, the bitstream do not carry the N entropy segments. In other words, if the value of this field is 1, the input data is divided into several segments and the several segments are processed according the embodiments provided by the present application. If the value of this field is 0, the input data is not processed according to the embodiments provided by the present application.

In addition to the segment flat information, the bitstream further carries some features of the input data. For example, the bitstream may carries the size of the input segment, the size of the input data, the size of the overlap region, and an alignment parameter of the analysis transform, or the like.

In some embodiments, the bitstream carrying the N entropy segments may be the bitstream 1 illustrated in FIG. 12, FIG. 13, FIG. 14, or FIG. 16.

FIG. 18 illustrates a flowchart of a decoding method provided by some embodiments of the present application. In some embodiments, the method illustrated in FIG. 18 may be performed by an electronic device. The electronic device is used for decoding the received bitstream. Therefore, in some embodiments, the electronic device may be referred to as a decoding device. In some other embodiments the method illustrated in FIG. 18 may be performed by a component of the decoding device. For example, the method illustrated in FIG. 18 may be implemented by a processor, a chip, a system on chip (SoC) or a processing circuitry of the decoding device. For convenience, the method illustrated in FIG. 18 will be described as being performed by the encoding device.

801, the decoding device obtains an entropy segment i from a bitstream.

The bitstream is determined by the encoding device. For example, the encoding device may perform the encoding method illustrated in FIG. 17 and determines the bitstream. The decoding device receives the bitstream from the encoding device and parse the bitstream to obtain the entropy segment i.

The entropy segment i is one of the N entropy segments carried by the bitstream. N is a positive integer greater than one, i=1, . . . N. The entropy segment i has no overlap region with its adjacent entropy segment. In other words, the entropy segments i is any one entropy segment among the N entropy segments. Each of the N entropy segments has no overlap region with its adjacent entropy segment. The N entropy segments may constitute a representation of an input data in a latent space.

In some embodiments, the decoding device may determine a location information corresponding to the entropy segment i according to an input segment corresponding to the entropy segment i, wherein the input segment corresponding to the entropy segment i is one input segment among M input segments, the M input segments constitute the input data, each of the M input segments comprises at least one overlap region with its adjacent input segment, M is a positive integer greater than one. Then, the decoding device may obtain the entropy segment i according to the location information corresponding to the entropy segment i from the bitstream.

In some embodiments, the decoding device may determine a shifted segment i according to the input segment corresponding to the entropy segment i and a size of the overlap region, determines a shifted latent segment i according to the shifted segment i and an alignment parameter of the synthesis transform, and determines the location information corresponding to the entropy segment i according to the shifted latent segment i and the shifted segment i.

802, the decoding device determines a synthesis segment i according to the entropy segment i and/or at least one entropy segment adjacent to the entropy segment i.

The synthesis segment i includes at least one overlap region with its adjacent synthesis segment.

For example, in some embodiments, the decoding device may determine location information of the synthesis segment i according to an alignment parameter of the synthesis transform and an input segment corresponding to the synthesis segment i, wherein the input segment corresponding to the synthesis segment i is one input segment among M input segments, the M input segments constitute the input data, each of the M input segments comprises at least one overlap region with its adjacent input segment. Then the decoding device determines, according to the location information of the synthesis segment i, elements of the synthesis segment i from the entropy segment i and/or at least one entropy segment adjacent to the entropy segment i.

803, the decoding device may determines a reconstructed segment i according to the synthesis segment i by performing a decoding network.

The decoding network is a network corresponding to the encoding network. The decoding network includes one or more operation corresponding to the operation(s) included in the encoding network. For example, the encoding network includes the analysis transform, while the decoding network includes a synthesis transform operation corresponding to the analysis transform operation. For example, the decoding device may perform the synthesis transform operation on the synthesis segment i to obtain the reconstructed segment.

In some embodiments, the decoding network may include one or more additional processing units. For example, the decoding network may include a post-filter. The post-filter may obtain outputs of the synthesis transform operation and processes the obtained segments. Under this condition, the output of the post-filter is the reconstructed segments. The main purpose of the synthesis transform operation is to transform the synthesis segments in the latent space into the signal space. The synthesis segments include overlap regions. The synthesis transform operation will not change this feature. Therefore, the transform result of the synthesis segments (hereinafter referred to as transformed synthesis segments) may also include the overlap regions. The post-filter may be used to remove the overlap regions from the transformed synthesis segments. Therefore, the reconstructed segments will have no overlap regions.

According to the method illustrated in FIG. 18, a pipe-line processing may be performed by the decoding device. The decoding device may obtain the first synthesis segment among the M synthesis segments and obtains a reconstructed segment corresponding to the first synthesis segments, then the decoding device may obtain the second synthesis segment among the M synthesis segments and obtains a reconstructed segment corresponding to the second synthesis segments and so on. Therefore, the decoding device do not have to obtain all synthesis segments to obtain the reconstructed segments.

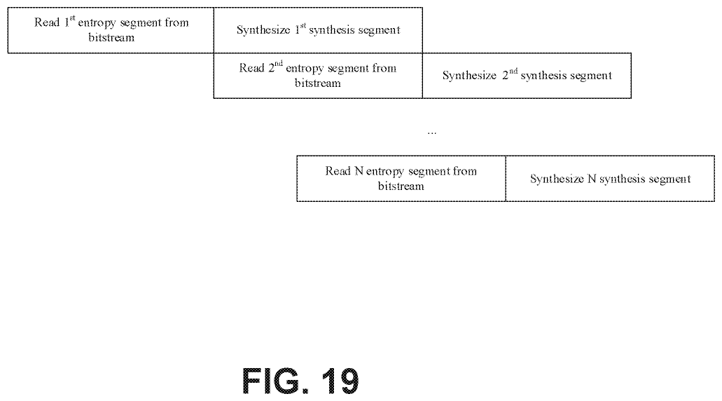

FIG. 19 illustrates the pipe-line process.

The decoding device may obtain M reconstructed segments. Each of the reconstructed segments has no overlap regions with its adjacent reconstructed segment. The decoding device may concatenate the M reconstructed segments to obtain a reconstructed data corresponding to the input data. In other words, the decoding device may crop the overlap regions according to the synthesis segments and concatenate the cropped segments to obtain the reconstructed data.

In order to help the skilled person better understand the technical solution of the present application, the following provides embodiments to the present application using an image as an input data. The input image may be divided into several image tiles.

In some embodiments, the decoding device may obtain the size of the tile, the size of the input image and the size of the overlap and determine the several image tiles according to the size of the tile, the size of the input image and the size of the overlap. For example, the image tiles may be determined as follows (hereinafter referred to as “the first tile determining operation”):

$$for tile\_start \_y in range ( 0 , image\_height - overlap , tile\_height - overlap ) :$$

$$for tile\_start \_x in range ( 0 , image\_width - overlap , tile\_width - overlap ) :$$

$$height = min ( tile\_height , image\_height - tile\_start \_y )$$

$$width = min ( tile\_width , image\_width - tile\_start \_x )$$

$${im\_tile}_{i} = ( tile\_start \_x , tile\_start \_y , width , height )$$

The im_tileᵢ is the i^{th} image tile among the several image tiles. The first tile determining operation may also be performed by the encoding device. For example, the encoding device may perform the first tile determining operation for dividing the input image into a plurality of image tiles. Then the image tiles may be processed in parallel by using the encoding network to obtain latent tiles corresponding to the image tiles.

For example, if the size of the input image is 3120*2424, the overlap is 64, and the size of the image tile is 1024*1024. Table 1 illustrates the image tiles corresponding to the input image.

TABLE 1

| im_tile | tile_start_x | tile_start_y | width | height |
|---|---|---|---|---|
| 1 | 0 | 0 | 1024 | 1024 |
| 2 | 960 | 0 | 1024 | 1024 |
| 3 | 1920 | 0 | 1024 | 1024 |
| 4 | 2880 | 0 | 240 | 1024 |
| 5 | 0 | 960 | 1024 | 1024 |
| 6 | 960 | 960 | 1024 | 1024 |
| 7 | 1920 | 960 | 1024 | 1024 |
| 8 | 2880 | 960 | 240 | 1024 |
| 9 | 0 | 1920 | 1024 | 504 |
| 10 | 960 | 1920 | 1024 | 504 |
| 11 | 1920 | 1920 | 1024 | 504 |
| 12 | 2880 | 1920 | 240 | 504 |

After determining the image tiles, the encoding device may determine latent tiles (that is the analysis segments) corresponding to the image tiles. Each image tile in signal space has a corresponding latent tile in latent space. The latent tile corresponds to the i^{th} image tile may be determined as follows (hereinafter referred to as “the second tile determining operation”):

```
image_tile = im_tileᵢ
lat_tile_start_y = image_tile.position.y // alignment_size
lat_tile_start_x = image_tile.position.x // alignment_size
if image_tile.size.height % alignment_size:
  height = math.ceil(image_tile.size.height / alignment_size)
else:
  height = image_tile.size.height // alignment_size
if image_tile.size.width % alignment_size:
  width = math.ceil(image_tile.size.width / alignment_size)
else:
  width = image_tile.size.width // alignment_size
lat_tileᵢ = (lat_tile_start_x, lat_tile_start_y, width, height)
```

The lat_tileᵢ is the i^{th} latent tile.

Using lat_tile, the corresponding region of the latent space is extracted and read/written from/to the bitstream. For this purpose, the overlapping part of the tile is disregarded in order to avoid reading/writing the same elements multiple times.

As previously mentioned, each latent tile has a corresponding image tile. So when the input image is divided into M image tiles, the encoding device may determine M latent tiles.

For example, when the aligntment_size=16, the latent tiles corresponding to the image tiles illustrated in Table 1 are illustrated in Table 2.

TABLE 2

| lat_tile | lat_tile_start_x | lat_tile_start_y | width | height |
|---|---|---|---|---|
| 1 | 0 | 0 | 64 | 64 |
| 2 | 60 | 0 | 64 | 64 |
| 3 | 120 | 0 | 64 | 64 |
| 4 | 180 | 0 | 15 | 64 |
| 5 | 0 | 60 | 64 | 64 |
| 6 | 60 | 60 | 64 | 64 |
| 7 | 120 | 60 | 64 | 64 |
| 8 | 180 | 60 | 15 | 64 |
| 9 | 0 | 120 | 64 | 31 |
| 10 | 60 | 120 | 64 | 31 |
| 11 | 120 | 120 | 64 | 31 |
| 12 | 180 | 120 | 15 | 31 |

After determining the latent tiles, the encoding device may determine core tiles (that is core segments) according to the latent tiles and the image tiles. The core tiles do not include the overlap region. The encoding device may concatenate the core tiles to obtain the representation of the input image in the latent space.

The following method extracts the non-overlapping parts of the tiles. The input is an image tile im_tileᵢ and its corresponding latent space tile lat_tileᵢ, taken from tg_bitstream and tg_lat_bitstream.

The core tiles may be determined as follows (hereinafter referred to as “the third tile determining operation”):

```
img_height = xxx # height of the image
img_width = xxx # width of the image
half_overlap = xxx # half amount of tile overlap
alignment_size = xxx # alignemnt size as describe befoe
(lat_tile_start_x, lat_tile_start_y, lat_tile_width, lat_tile_height) =
lat_tile;
(tile_start_x, tile_start_y, tile_width, tile_height) = im_tileᵢ
overlap_left = 0 if tile_start_x == 0 else half_overlap // alignment_size
overlap_top = 0 if tile_start_y == 0 else half_overlap // alignment_size
overlap_right = 0 if tile_start_x + tile_width >= img_width else
half_overlap // alignment_size
overlap_bottom = 0 if tile_start_y + tile_height >= img_height else
half_overlap // alignment_size
core_tile = (
  lat_tile_start_x + overlap_left,
  lat_tile_start_y + overlap_top,
  lat_tile_width − overlap_right − overlap_left,
  lat_tile_height − overlap_bottom − overlap_top,
)
```

According to the image tiles illustrated in Table 1 and the latent tiles illustrated in Table 2, the core tiles illustrated in Table 3 may be determined.

TABLE 3

| core_tile | core_tile_start_x | core_tile_start_y | width | height |
|---|---|---|---|---|
| 1 | 0 | 0 | 62 | 62 |
| 2 | 62 | 0 | 60 | 62 |
| 3 | 122 | 0 | 60 | 62 |
| 4 | 182 | 0 | 13 | 62 |
| 5 | 0 | 62 | 62 | 60 |
| 6 | 62 | 62 | 60 | 60 |
| 7 | 122 | 62 | 60 | 60 |
| 8 | 182 | 62 | 13 | 60 |
| 9 | 0 | 122 | 62 | 29 |
| 10 | 62 | 122 | 60 | 29 |
| 11 | 122 | 122 | 60 | 29 |
| 12 | 182 | 122 | 13 | 29 |

The third tile determining operation is used to determine core tiles for latent tiles, which is used by encoding device to crop latent tiles. Meanwhile, the third determining operation may also be performed by the decoding device. As previous mentioned, the transform result of the synthesis tiles (synthesis segments) may also include the overlap region. The decoding device may perform the third tile determining operation on the transformed synthesis tiles (that is the transform result of the synthesis tiles) to crop the overlap regions. When the third tile determining operation is performed by the decoding device to crop the overlap regions, the third tile determining operation may be take the following adjustments: the lat_tile_i would need to be same as im_tile_i, and alignement_size=1.

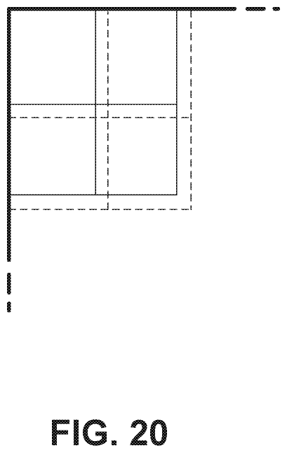

The tiles for obtaining the reconstructed image are different from tiles read from the bitstream. FIG. 20 illustrates the tiles for determining the reconstructed image and the tiles read from the bitstream.

The solid tiles illustrated in FIG. 20 are the tiles used for determining the reconstructed image.

The dashed tiles are the tiles read from the bitstream. According to the dashed tiles, pipelined processing is possible, starting at top left, processing per row. After a dashed tile has been read from the bitstream, synthesis of the corresponding core tile can directly be started without causing errors in the reconstruction. The dashed tiles are a shifted version of the tiles used for synthesis. Special case may occur at the image borders: first tiles are larger, last tiles may be empty.

The dashed tiles may be determined according to the image tiles. The decoding device may determine shifted tiles corresponding to the image tiles. Then the decoding device determines latent tiles corresponding to the shifted tiles (hereinafter referred to as shifted latent tiles). At last, the decoding device may determine the dashed tiles according to the shifted tiles and the shifted latent tiles. The method for determining the dashed tiles according to the shifted tiles and the shifted latent tiles is the same as the method for determining the core tiles according to the image tiles and the latent tiles. For the sake of brevity, it will not be retreated here. The dashed tiles may also be referred to as shifted core tiles. The method for determining the shifted latent tiles according to the shifted tiles is the same as the method for determining the latent tiles according to the image tiles. For the sake of brevity, it will not be repeated here.

The shifted tiles may be determined according to the image tiles. One possible approach for determining the shifted tiles are follows:

```
img_height = xxx # height of the image
img_width = xxx # width of the image
half_overlap = xxx # half amount of tile overlap
shifted_image_tiles = [ ]
reached_bottom_border = False
for tiles_row in tg_synth:
  shifted_tile_row = [ ]
  reached_right_border = False
  if reached_bottom_border:
    shifted_tile_row = [None for im_tile in tiles_row] # None means
  this tile writes/read nothing to/from the bitstream. This has already been
  done by the second-to-last tile in the row/colum (which may also be the
  first and only).
    shifted_image_tiles.append(shifted_tile_row)
    continue
  for im_tileᵢ in tiles_row:
    (tile_start_x, tile_start_y, tile_width, tile_height) = im_tilei
    if reached_right_border:
      shifted_tile_row.append(None)
      continue
    if tile_start_x == 0:
      shifted_start_x = 0
      if tile_width + half_overlap < img_width:
        width = tile_width + half_overlap
      else:
        width = img_width
        reached_right_border = True
      else:
        shifted_start_x = tile_start_x + half_overlap
        if tile_width < img_width − shifted_start_x:
          width = tile_width
        else:
          width = img_width − shifted_start_x
          reached_right_border = True
      if tile_start_y == 0:
        shifted_start_y = 0
        if tile_height + half_overlap < img_height:
          height = tile_height + half_overlap
        else:
          height = img_height
          reached_bottom_border = True
      else:
        shifted_start_y = tile_start_y + half_overlap
        if tile_height < img_height − shifted_start_y:
          height = tile_height
        else:
          height = img_height − shifted_start_y
          reached_bottom_border = True
      shifted_tile_i = (shifted_start_x, shifted_start_y, width, height)
      shifted_tile_row.append(shifted_tile_i)
    shifted_image_tiles.append(shifted_tile_row)
```

Table 4 illustrates the shifted tiles determined according to the image tiles illustrated in Table 1.

TABLE 4

| | shifted_ | | | |
|---|---|---|---|---|
| shifted_tile | start_x | shifted_start_y | width | height |
| 1 | 0 | 0 | 1056 | 1056 |
| 2 | 992 | 0 | 1024 | 1056 |
| 3 | 1952 | 0 | 1024 | 1056 |
| 4 | 2912 | 0 | 208 | 1056 |
| 5 | 0 | 992 | 1056 | 1024 |
| 6 | 992 | 992 | 1024 | 1024 |
| 7 | 1952 | 992 | 1024 | 1024 |
| 8 | 2912 | 992 | 208 | 1024 |
| 9 | 0 | 1952 | 1056 | 472 |
| 10 | 992 | 1952 | 1024 | 472 |
| 11 | 1952 | 1952 | 1024 | 472 |
| 12 | 2912 | 1952 | 208 | 472 |

Table 5 illustrates the shifted latent tiles determined according to the shifted tiles illustrated in Table 4.

TABLE 5

| | shifted_ | shifted_ | | |
|---|---|---|---|---|
| shifted_lat_tile | lat_start_x | lat_start_y | width | height |
| 1 | 0 | 0 | 66 | 66 |
| 2 | 62 | 0 | 64 | 66 |
| 3 | 122 | 0 | 64 | 66 |
| 4 | 182 | 0 | 13 | 66 |
| 5 | 0 | 62 | 66 | 64 |
| 6 | 62 | 62 | 64 | 64 |
| 7 | 122 | 62 | 64 | 64 |
| 8 | 182 | 62 | 13 | 64 |
| 9 | 0 | 122 | 66 | 29 |
| 10 | 62 | 122 | 64 | 29 |
| 11 | 122 | 122 | 64 | 29 |
| 12 | 182 | 122 | 13 | 29 |

Table 6 illustrates the shifted core tiles determined according to the shifted tiles illustrated in Table 4 and the shifted latent tiles illustrated in Table 5.

TABLE 6

| | shifted_ | shifted_ | | |
|---|---|---|---|---|
| | core_start_ | core_start_ | | |
| shifted_core_tile | x | y | width | height |
| 1 | 0 | 0 | 64 | 64 |
| 2 | 64 | 0 | 60 | 64 |
| 3 | 124 | 0 | 60 | 64 |
| 4 | 184 | 0 | 11 | 64 |
| 5 | 0 | 64 | 64 | 60 |
| 6 | 64 | 64 | 60 | 60 |
| 7 | 124 | 64 | 60 | 60 |
| 8 | 184 | 64 | 11 | 60 |
| 9 | 0 | 124 | 64 | 27 |
| 10 | 64 | 124 | 60 | 27 |
| 11 | 124 | 124 | 60 | 27 |
| 12 | 184 | 124 | 11 | 27 |

The encoding device performs similar procedures to determine tiles written to the bitstream (that this the shifted core tiles). For the sake of brevity, it will not be retreated here.

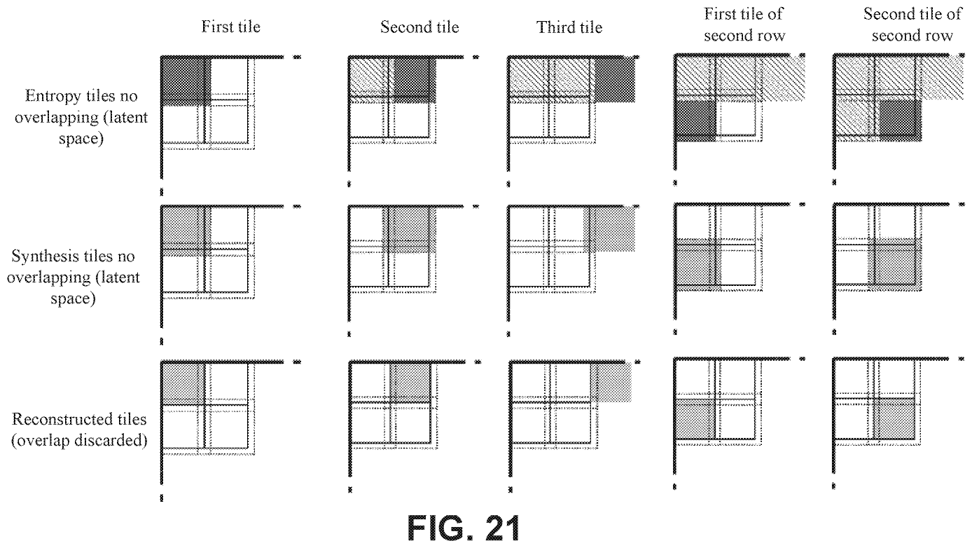

FIG. 21 illustrates entropy tiles (that is the shifted core tiles), the synthesis tiles (that is the latent tiles), and reconstructed tiles (that is the core tiles).

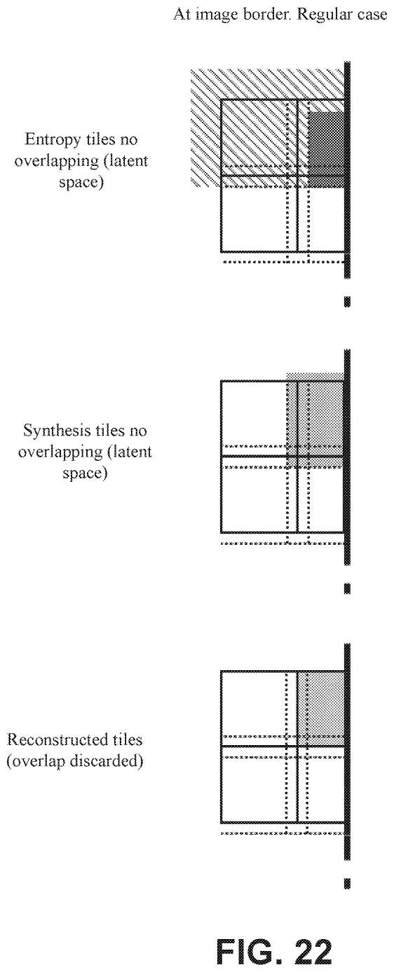

FIG. 22 illustrates entropy tiles, the synthesis tiles and the reconstructed tiles in a regular case.

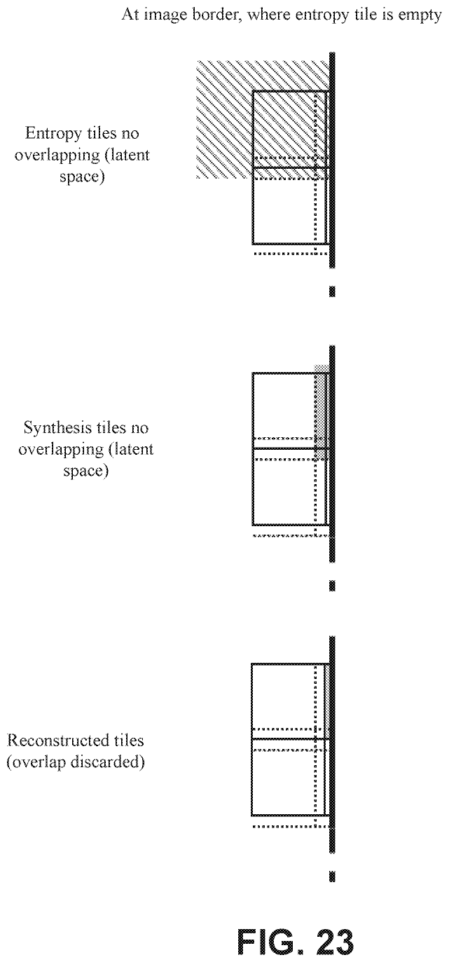

FIG. 23 illustrates entropy tiles, the synthesis tiles and the reconstructed tiles in a special case.

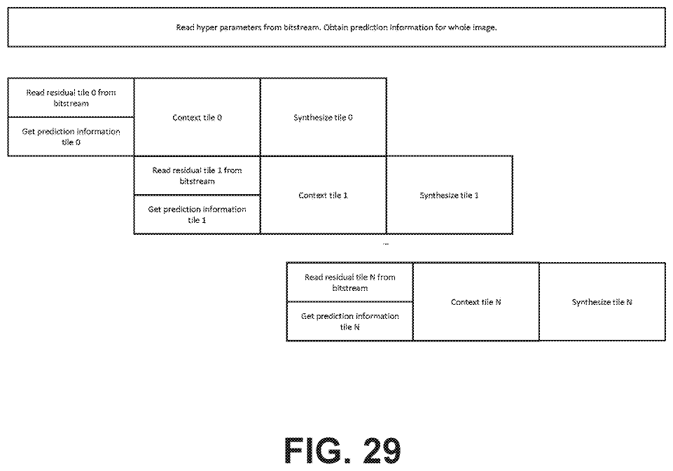

Therefore, in embodiments of the present invention, tiles are also used in the entropy coding. The data necessary for the decoding of a tile is coded separately for each tile. This allows pipe-line processing by the decoder. Here, the pipeline comprises reading a tile from the bitstream and then synthesizing it, as illustrated in FIG. 19 (and later in FIG. 29 with context).

The latent-space tiles that are used for synthesis of the image overlap each other by one or more latent-space regions. This overlap avoids visible block boundaries in the decoded image and has no impact on the coding performance. Because of this overlap, the same set of tiles cannot be directly used to determine which samples should be written to the bitstream by the encoder. This would lead to writing the same samples multiple times at increase the bitrate. This issue is solved by deriving a new set of “entropy tiles” (entropy segments) based on the set of tiles that is used for synthesis of the image (synthesis segments). For each synthesis tile, one entropy tile is derived that defines which samples need to written/read from the bitstream in order to decode the corresponding synthesis tile. This is performed in such a manner that each latent space sample only needs to be written/read once to/from the bitstream.

In the decoder, luma and chroma are decoded separately. However, decoding of the chroma component requires both chroma and luma latent space (i.e. CCS).

In the following, first the synthesis tile map (or tile grid) is derived. It is then used as a basis for deriving the tile grid used in entropy coding.

Several ways for obtaining the synthesis tile map are possible. Some exemplary implementations are:
1. A tile map is signaled explicitly only for the primary component. Other components use the same tile map (for YUV420 and CCS primary component would be luma/Y and the other component would be chroma/UV).
2. A tile map is signaled explicitly for each component of the image.

When a tile map is signaled explicitly, this could be performed in one of the following exemplary ways:
1. A regular grid of tiles with the same size (except at bottom and right boundaries) is used. An offset and a size value are signaled, from which the tile map can be derived (see below).
2. A regular grid of tiles with the same size (except at bottom and right boundaries) is used. An offset and a size value are used, but not signaled directly. Instead size and offset value are derived from an already decoded level definition. The tile map can be derived from the size and offset value (see below).
3. An arbitrary grid of tiles is used. First the number of tiles is signaled, then for each tile its position and size are signaled (overlaps would implicitly be included in this signaling).

If the tile map is signaled via values (in signal space sizes/coordinates) for tile size (tile width equals height) and overlap, the N overlapping regions may be derived as follows:

$$for tile\_start \_y in range ( 0 , image\_height - overlap , tile\_height - overlap ) :$$

$$for tile\_start \_x in range ( 0 , image\_width - overlap , tile\_width - overlap ) :$$

$$height = min ( tile\_height , image\_height - tile\_start \_y )$$

$$width = min ( tile\_width , image\_width - tile\_start \_x )$$

$${im\_tile}_{i} = ( tile\_start \_x , tile\_start \_y , width , height )$$

Each tile used for reading/writing to the bitstream can be synthesized separately. The overlapping regions should not be encoded twice (increased bitrate). Further, the overlap regions are already read from the bitstream, before a particular tile is synthesized.

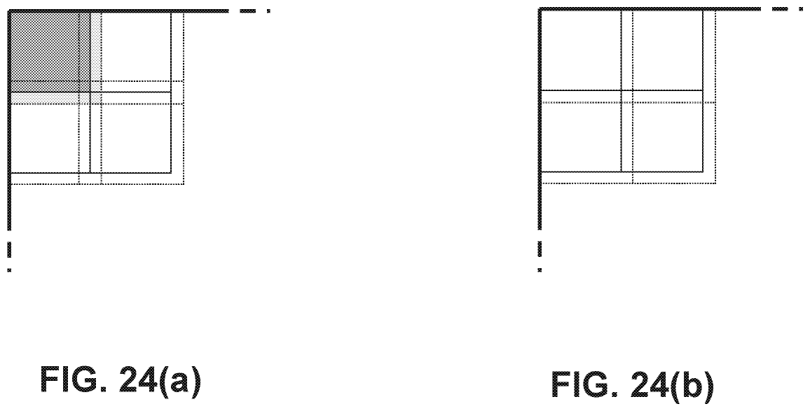

FIG. 24(a) summarizes the tile grid used for synthesis. In the top left, the image border is shown. The solid lines are the core tiles (i.e. the regions that will be kept after synthesis). The dashed lines illustrate the overlap regions. The dark filled are shows a first core tile. The light filled area illustrates the first tile including the overlap used for synthesis. If core tiles are used for reading/writing the bitstream, not all required elements will be available at synthesis time if pipelined processing is used: the samples of overlapping regions are also used. However, if overlapping regions are used for reading/writing bitstream, elements will be written/read multiple times (increasing bitrate).

FIG. 24(b) summarizes the tile grid used for reading/writing bitstream. In the top left, the image border is shown. The solid lines are the core tiles. The dashed lines illustrate the tiles that are used for reading/writing the bitstream. Pipelined processing is possible, starting at top left, processing per row. After a dashed tile has been read from the bitstream, synthesis of the corresponding core tile can directly be started without causing errors in the reconstruction. Mainly, this tile grid is a shifted version of the tile grid used for synthesis. However, a special case occurs at the image borders. The first tile is larger, and the last tile may be empty (already read/written to/from bitstream by second-to-last tiles).

For this reason, the arrangement of tiles (which may be referred to as the tile grid) used for synthesis is slightly different from the tile grid used for reading/writing of the bitstream. Approximately, the latter is a to the bottom-right direction shifted version of the former. Precisely, the tile grid used for reading/writing the bitstream (tg_bitstream) is derived from the tile grid used for synthesis:

$$tg\_synth [ y ] [ x ]$$

where tg_synth is a 2d array storing the parameters for each tile (im_tileᵢ). The derivation may be as described above for the shifted tiles.

In one example, tiles used in entropy coding can be signaled as illustrated in Table 7 and Table 8 below. A flag can be added to the tile header of each component. If the flag is equal to 1, tiles are used in entropy coding.

TABLE 7

| | Descriptor |
|---|---|
| tile_header_Luma(tile_signaling_type) { | |
| tile_enable_Luma | u(1) |
| if (tile_enable_Luma) | |
| tile_size_Luma | u(13) |
| tile_overlap_Luma | u(8) |
| code_residual_per_tile | u(1) |
| } | |

TABLE 8

| | Descriptor |
|---|---|
| tile_header_Chroma(tile_signaling_type) { | |
| tile_enable_Chroma | u(1) |
| tile_size_Chroma | u(13) |
| tile_overlap_Chroma | u(8) |
| code_residual_per_tile | u(1) |
| } | |

In another architecture, the decoder can include a context module. Using a context module allows for a better prediction, which leads to a smaller of additional information that needs to be encoded, i.e. for a similar quality, the required bitrate is smaller.

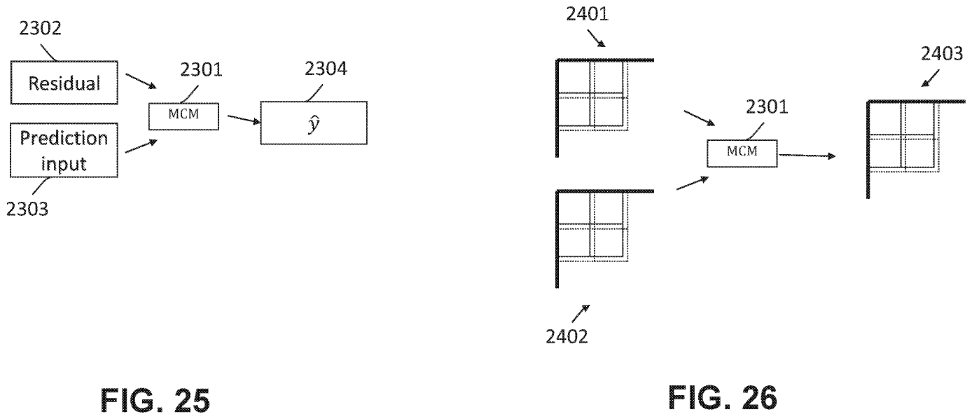

As schematically illustrated in FIG. 25, the input to the context model 2301 (MCM) in the decoder is the residual 2302, which is read from the bitstream, and prediction information 2303 (from the hyper decoder). The output of the context model is ŷ (the image transformed to latent space).

As illustrated by FIG. 26, when a context module is part of the pipeline in the decoder where tiles are used, the tiles that are output by the context module include one or more overlapping regions which are used by the synthesis transform. The data of the overlapping regions of neighbouring tiles may differ. For this reason, this data is not stored in the form of one large tensor, but kept separate. Only after synthesis transform has been performed are the reconstructed tiles are merged into a single image.

In traditional approaches, tiles are not used in the context module. This breaks the pipeline, as ŷ is generated by the context module. Previously, instead of context there was simply addition of residual and prediction (mean), which was a point-wise operation and no special care was needed for pipelining

In embodiments of the present invention, the same tiles as for synthesis transform are used as input to the context module. These tiles comprise one or more overlap regions with their adjacent tiles. This allows a pipelined process to be used. Only the non-overlapping part of the ŷ generated by the context is used to form the reconstructed tiles.

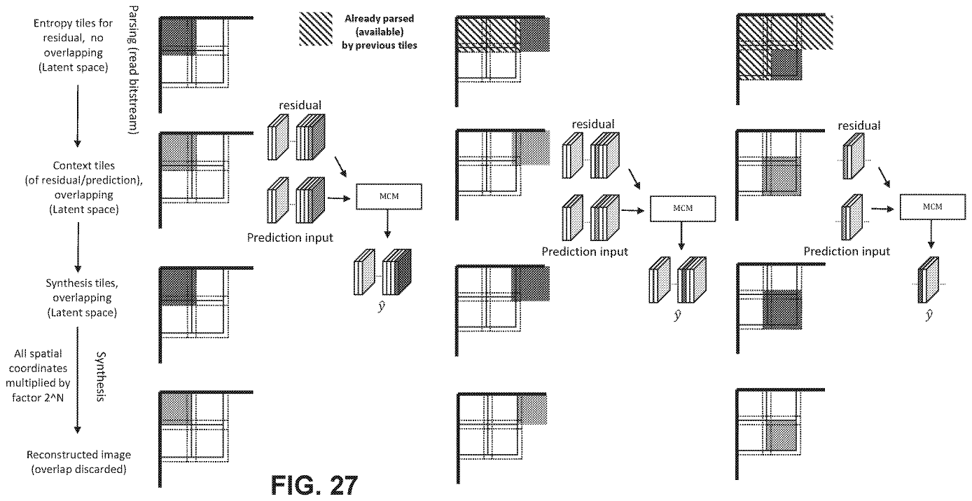

FIG. 27 schematically illustrates the shape of three different tiles as they pass through the pipeline in the decoder. In the top row, the residual tile is read from the bitstream. The hatched areas shown previously parsed data. In the second row, the shaded areas illustrate the tiles that are used to extract residual and prediction input used by the context module. In the third row, the shaded areas illustrate tiles of ŷ that are used by the synthesis transform. On the bottom row, the shaded areas show the reconstructed samples in the image domain that are stored in the image, with the overlapping regions disregarded. Data associated with the shaded tiles shown in the first, second and fourth rows used for entropy tiles, the residual, the prediction input and the reconstructed tiles can be stored in form of one large tensor/image. When the context module is used, this is not possible for data associated with the tiles of ŷ. Here, the overlapping regions may be different for different tiles.

In one example, the context module (MCM 2301 in FIGS. 25 and 26) operates in k stages (MCMₖ), where k=0, 1, . . . , k. Before the context module is used, the tensor with an explicit prediction input μ and the residual tensor r are split equally along the channel dimension into multiple tensors μₖ and rₖ. A stage of the context predicts first mean values using already reconstructed parts of ŷ of the previous stages. The part of ŷ of the current stage is then obtained by adding the predicted mean values for the current stage to the decoded/parsed residual of the current stage.

In this example, in the first stage of the context, mean values are predicted using the context model MCM₀ on explicit prediction input 0 and a tensor of the same size initialized with 0s. The mean values are added to r₀ to give ŷ₀.

In the second stage of the context, mean values are predicted using the context model MCM₁ on explicit prediction input 1 and a tensor ŷ₀. The mean values are added to r₁ to give ŷ₁.

In the third stage of the context, mean values are predicted using the context model MCM₂ on explicit prediction input 2 and the concatenated tensors (along channel dimension) [ŷ₀,ŷ₁]. The mean values are added to r₂ to give ŷ₂.

In the fourth stage of the context, mean values are predicted using the context model MCM₃ on explicit prediction input 3 and the concatenated tensors (along channel dimension) [ŷ₀, ŷ₁, ŷ₂]. The mean values are added to r₃ to give ŷ₃.

There may be further stages (i.e. k>3). Here, four stages (k=3) are described for simplicity.

A context model can also be included in the encoder. The encoder uses the same context model neural network as used by the decoder. However, as described previously (for the decoder) the model takes inputs of the explicit prediction parameters and the residual and generates ŷ. In order to take inputs y and explicit prediction parameters and generate the residual, the encoder additionally does the following:

In each stage, mean values are predicted based on explicit prediction input and previously reconstrued ŷ. \vec{y} by previous stages of context module, can slightly differ from y, as quantization is applied here. y, produced by the analysis transform, is not yet quantized. These mean values are then subtracted from the y to obtain the residual of the current stage of the context.

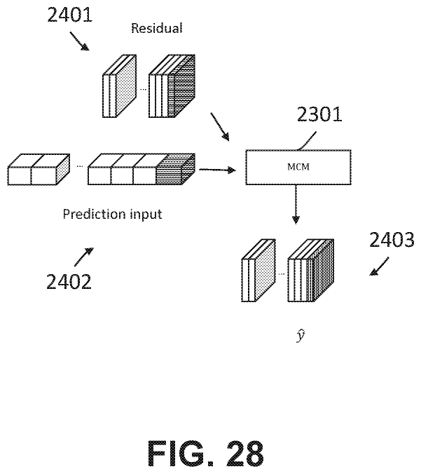

FIG. 28 illustrates that the two tiles input to the context module (the residual and the prediction input) have the same total numbers of elements. That is, the residual tile has the same number of elements as the prediction input tile. In the examples shown in FIG. 28, the spatial dimension of the second context segment i is a quarter of the spatial dimension of the first context segment i, but the second context segment i has 4 times the number of channels than the first context segment.

Where the encoder and/or decoder comprise a context module, the context is also part of the pipeline, as shown in FIG. 29. As shown in this Figure, the residual tile 0 is read from the bitstream, and the prediction information is obtained for tile 0 simultaneously. In the next stage of the pipeline, the context for tile 0 is determined by inputting the residual and the prediction information for tile 0 into the context model. At the same time, the residual tile 1 is read from the bitstream, and the prediction information is obtained for tile 1. In the next stage, tile 0 is synthesized and the context is determined for tile 1 by inputting the residual and the prediction information for tile 1 into the context model.

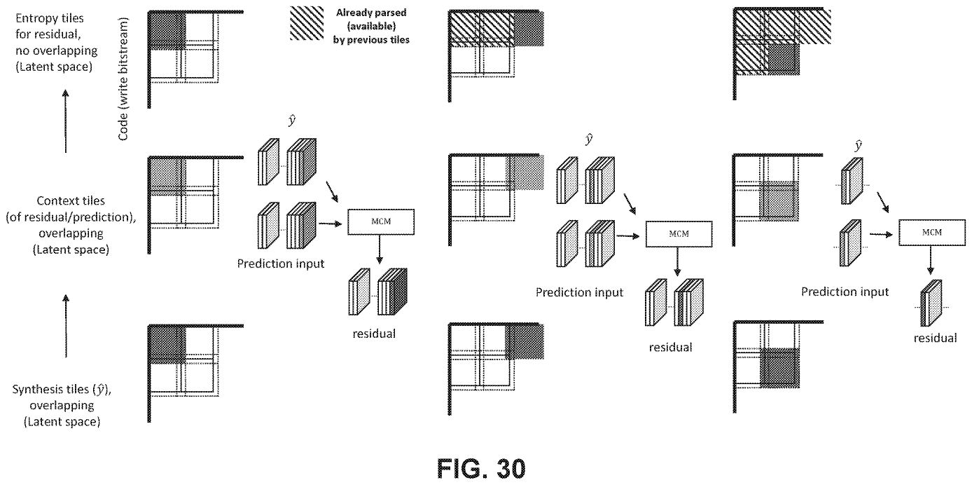

FIG. 30 schematically illustrates the shape of three different tiles as they pass through the pipeline in the encoder. In the bottom row, the residual tile, comprising one or more overlapping regions with one or more adjacent residual tiles, is read from bitstream. The hatched areas shown previously parsed data. In the second row, the shaded areas illustrate the tiles that are used to extract residual and prediction input used by the context module. In the third row, the shaded areas illustrate tiles of ŷ that are used by the synthesis transform. On the bottom row, the shaded areas show the reconstructed samples in the image domain that are stored in the image, with the overlapping regions disregarded.

At the decoder, the inputs to the context module are the prediction information (from the hyper decoder) and the residual, read from the bitstream. These input are referred to herein as first and second context segments/tiles. The output of the context module at the decoder is ŷ (the image transformed to latent space). The modification of the decoder process is that the context is not applied to whole latent space at once, but per tile. The first and second context tiles are input to the context module.

At the encoder, the inputs to the context module are the prediction information (from the hyper decoder) and ŷ (the input image transformed to latent space). The output of the context module at the encoder is the residual, which is then encoded in the bitstream. The modification of the encoder process is that the context is not applied to whole latent space at once, but also per tile.

As shown in FIG. 25, both inputs to the context module have the one or more overlap regions of the tiles, as do the output tiles. That is, the synthesis tiles (f), the prediction input tiles and the residual tiles all have one or more overlap regions with one or more adjacent tiles of the same type. The overlap regions are disregarded in the determination of the reconstructed tiles (in the decoder) and the entropy tiles (encoded in the bitstream).

This method thus supports pipe-lined reading from and writing to the bitstream, application of a context model per tile and the synthesis of tiles.

The use of tiles can reduce the memory needed for decoding of the image. In the state-of-the art, the whole latent space needs to be parsed/read from the bitstream, before the first tile can be decoded. Embodiments of the present invention can advantageously allow for pipelined decoding and synthesis of image regions using neural networks.

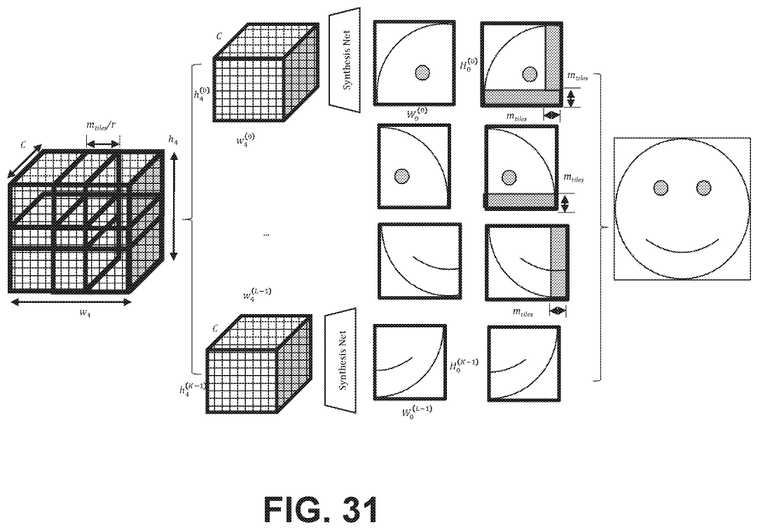

FIG. 31 illustrates a decoding procedure. The decoding device may determine four latent tiles (FIG. 31 merely illustrates two latent tiles), determine four image tiles and four core tiles, and determine the reconstructed image according to the four core tiles.

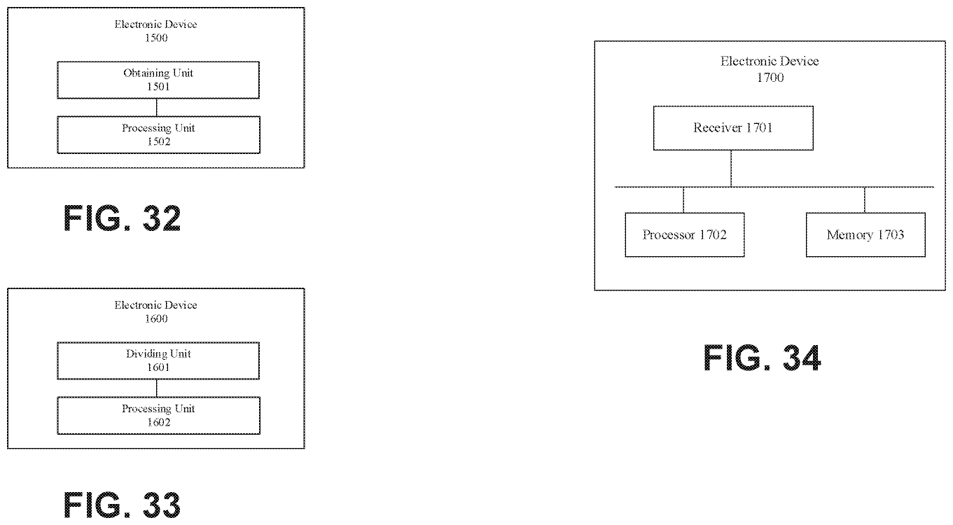

FIG. 32 is a schematic block diagram of an electronic device 1500 according to some embodiments of the present application. Referring to FIG. 32, the electronic device 1500 includes an obtaining unit 1501 and a processing unit 1502.

The obtaining unit 1501 is configured to obtain an entropy segment i from a bitstream, where the entropy segment i is one entropy segment among N entropy segments, the N entropy segments constitute a representation of an input data in a latent space, the entropy segment i has no overlap region with its adjacent entropy segment, N is a positive integer greater than one, i=1, . . . , N.

The processing unit 1502 is configured to determine a synthesis segment i according to the entropy segment i and/or at least one entropy segment adjacent to the entropy segment i, wherein the synthesis segment i comprises at least one overlap region with its adjacent synthesis segment.

The processing unit 1502 is further configured to determine a reconstructed segment i according to the synthesis segment i by performing a decoding network, wherein the reconstructed segment i has no overlap region with its adjacent reconstructed segment.

The processing unit 1502 may be implemented by a processor. In some embodiments, the obtaining unit 1501 may be implemented by the processor.

Details on how to process the input image may refer to the above-mentioned embodiments and will not be described here.

FIG. 33 is a schematic block diagram of an electronic device 1600 according to some embodiments of the present application. Referring to FIG. 33, the electronic device 1600 includes a dividing unit 1601 and a processing unit 1602.

The dividing unit 1601 is configured to divide an input data into M input segments, wherein each of the M input segments comprises at least one overlap region with its adjacent input segment, M is a positive integer greater than one.

The processing unit 1602 is configured to determine M analysis segments by processing the M input segments using an encoding network, wherein the M analysis segments and the M input segments are in one-to-one correspondence.

The processing unit 1602 is further configured to determine a representation of the input data in a latent space according to the M analysis segments and the M input segments.

The processing unit 1602 is further configured to divide the representation of the input data into N entropy segments, wherein each of the N entropy segments has no overlap region with its adjacent entropy segment, N is a positive integer greater than one;

The processing unit 1602 is further configured to determine a bitstream by encoding the N entropy segments.

The processing unit 1602 may be implemented by a processor. In some embodiments, the dividing unit 1601 may be implemented by the processor.

Details on how to process the input image may refer to the above-mentioned embodiments and will not be described here.

As shown in FIG. 34, an electronic device 1700 may include a receiver 1701, a processor 1702, and a memory 1703. The memory 1703 may be configured to store code, instructions, and the like executed by the processor 1702.

It should be understood that the processor 1702 may be an integrated circuit chip and has a signal processing capability. In an implementation process, steps of the foregoing method embodiments may be completed by using a hardware integrated logic circuit in the processor, or by using instructions in a form of software. The processor may be a general purpose processor, a central processing unit (CPU), a graphics processing unit (GPU), a neural processing unit (NPU), a system on chip (SoC) or another programmable logic device, a discrete gate or transistor logic device, or a discrete hardware component. The processor may implement or perform the methods, the steps, and the logical block diagrams that are disclosed in the embodiments of the present application. The general purpose processor may be a microprocessor, or the processor may be any conventional processor or the like. The steps of the methods disclosed with reference to the embodiments of the present application may be directly performed and completed by the processor, or may be performed and completed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps of the foregoing methods performed by the encoding device or the decoding device in combination with hardware in the processor.

It may be understood that the memory 1703 in the embodiments of the present application may be a volatile memory or a nonvolatile memory, or may include both a volatile memory and a nonvolatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

It should be noted that the memory in the electronic device and the methods described in this specification includes but is not limited to these memories and a memory of any other appropriate type.

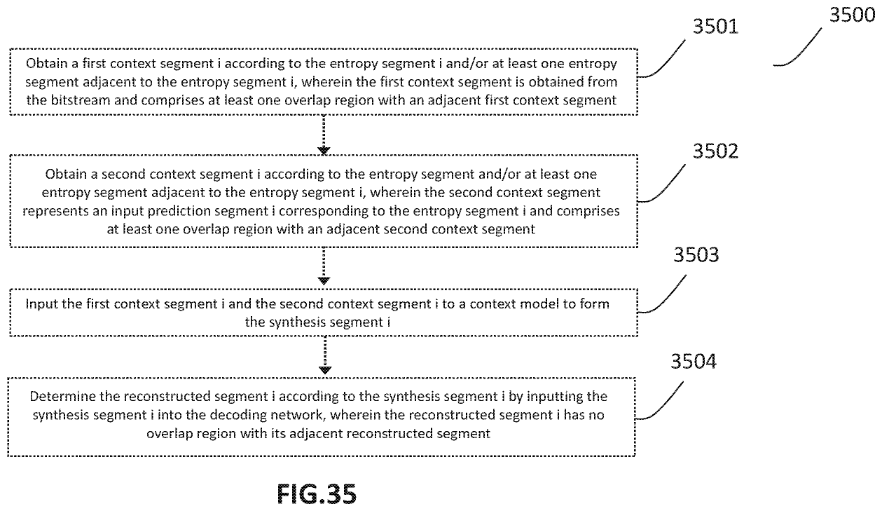

FIG. 35 is a flow diagram illustrating an exemplary method 3500 for decoding an image based on a neural network architecture. This method can be used when the decoder comprises a context model. At step 3501, the method comprises obtaining a first context segment i according to the entropy segment i and/or at least one entropy segment adjacent to the entropy segment i, wherein the first context segment is obtained from the bitstream and comprises at least one overlap region with an adjacent first context segment. At step 3502, the method comprises obtaining a second context segment i according to the entropy segment and/or at least one entropy segment adjacent to the entropy segment i, wherein the second context segment represents an input prediction segment i corresponding to the entropy segment i and comprises at least one overlap region with an adjacent second context segment. At step 3503, the method comprises inputting the first context segment i and the second context segment i to a context model to form the synthesis segment i. At step 3504, the method comprises determining the reconstructed segment i according to the synthesis segment i by inputting the synthesis segment i into the decoding network, wherein the reconstructed segment i has no overlap region with its adjacent reconstructed segment.

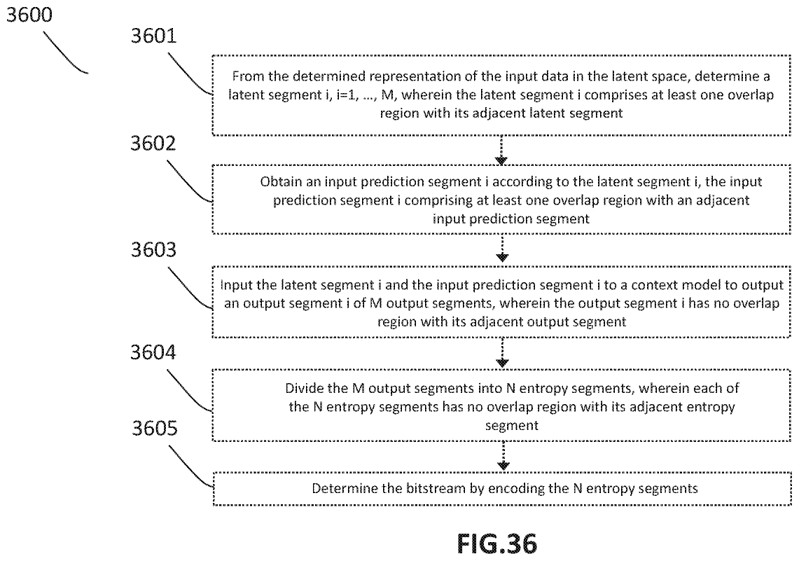

FIG. 36 is a flow diagram illustrating an exemplary method 3600 for encoding. The embodiment according to FIG. 36 may be configured to provide output readily decoded by the decoding method described with reference to FIG. 35. The method 3600 of FIG. 36 will be described as being performed by a neural network system of one or more computers located in one or more locations. For example, a system configured to perform image compression, e.g., the neural network of FIG. 1 can perform the method 3600. This method can be used when the encoder comprises a context model. At step 3601, the method comprises, from the determined representation of the input data in the latent space, determining a latent segment i, i=1, . . . , M, wherein the latent segment i comprises at least one overlap region with its adjacent latent segment. At step 3602, the method comprises obtaining an input prediction segment i according to the latent segment i, the input prediction segment i comprising at least one overlap region with an adjacent input prediction segment. At step 3603, the method comprises inputting the latent segment i and the input prediction segment i to a context model to output an output segment i of M output segments, wherein the output segment i has no overlap region with its adjacent output segment. At step 3604, the method comprises dividing the M output segments into N entropy segments, wherein each of the N entropy segments has no overlap region with its adjacent entropy segment. At step 3605, the method comprises determining the bitstream by encoding the N entropy segments.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

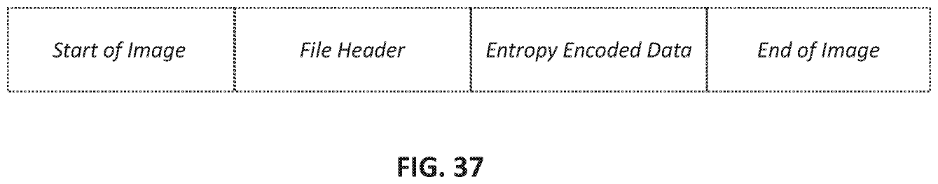

FIG. 37 illustrates one example of a bitstream. The bitstream may comprise a marker indicating the start of the bitstream, header data including, for example, picture header data or tool header data, entropy-encoded data, and optionally padding which may include an end of code stream marker. In one particular example, the bitstream comprises blocks of data. Each block of data is decodable by the decoder. The decoder may obtain the entropy segments from the bitstream, as described herein. The bitstream may be non-transient. The bitstream may be stored on a data carrier.

### Some Exemplary Implementations in Hardware and Software

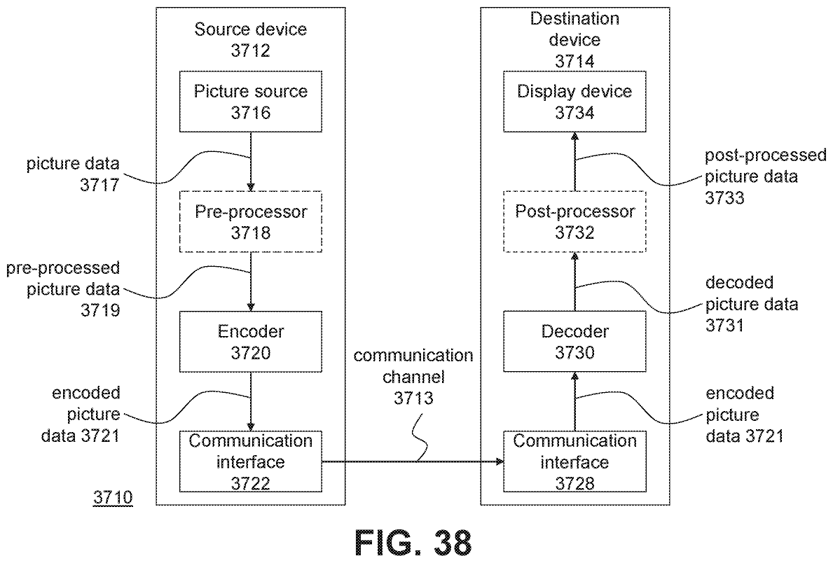

The corresponding system which may deploy the above-mentioned encoder-decoder processing chain is illustrated in FIG. 38. FIG. 38 is a schematic block diagram illustrating an example coding system, e.g. a video, image, audio, and/or other coding system (or short coding system) that may utilize techniques of this present application. Video encoder 3720 (or short encoder 3720) and video decoder 3730 (or short decoder 3730) of video coding system 3710 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

As shown in FIG. 38, the coding system 3710 comprises a source device 3712 configured to provide encoded picture data 3721 e.g. to a destination device 3714 for decoding the encoded picture data 3713.

The source device 3712 comprises an encoder 3720, and may additionally, i.e. optionally, comprise a picture source 3716, a pre-processor (or pre-processing unit) 3718, e.g. a picture pre-processor 3718, and a communication interface or communication unit 3722.

The picture source 3716 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 3718 and the processing performed by the pre-processing unit 3718, the picture or picture data 3717 may also be referred to as raw picture or raw picture data 3717.

Pre-processor 3718 is configured to receive the (raw) picture data 3717 and to perform pre-processing on the picture data 3717 to obtain a pre-processed picture 3719 or pre-processed picture data 3719. Pre-processing performed by the pre-processor 3718 may, e.g., comprise trimming, color format conversion (e.g. from RGB to YCbCr), color correction, or de-noising. It can be understood that the pre-processing unit 3718 may be optional component. It is noted that the pre-processing may also employ a neural network (such as in any of FIGS. 1 to 7) which uses the presence indicator signaling.

The video encoder 3720 is configured to receive the pre-processed picture data 3719 and provide encoded picture data 3721.

Communication interface 3722 of the source device 3712 may be configured to receive the encoded picture data 3721 and to transmit the encoded picture data 3721 (or any further processed version thereof) over communication channel 3713 to another device, e.g. the destination device 3714 or any other device, for storage or direct reconstruction.

The destination device 3714 comprises a decoder 3730 (e.g. a video decoder 3730), and may additionally, i.e. optionally, comprise a communication interface or communication unit 3728, a post-processor 3732 (or post-processing unit 3732) and a display device 3734.

The communication interface 3728 of the destination device 3714 is configured receive the encoded picture data 3721 (or any further processed version thereof), e.g. directly from the source device 3712 or from any other source, e.g. a storage device, e.g. an encoded picture data storage device, and provide the encoded picture data 3721 to the decoder 3730.

The communication interface 3722 and the communication interface 3728 may be configured to transmit or receive the encoded picture data 3721 or encoded data 3713 via a direct communication link between the source device 3712 and the destination device 3714, e.g. a direct wired or wireless connection, or via any kind of network, e.g. a wired or wireless network or any combination thereof, or any kind of private and public network, or any kind of combination thereof.

The communication interface 3722 may be, e.g., configured to package the encoded picture data 3721 into an appropriate format, e.g. packets, and/or process the encoded picture data using any kind of transmission encoding or processing for transmission over a communication link or communication network.

The communication interface 3728, forming the counterpart of the communication interface 3722, may be, e.g., configured to receive the transmitted data and process the transmission data using any kind of corresponding transmission decoding or processing and/or de-packaging to obtain the encoded picture data 3721.

Both, communication interface 3722 and communication interface 3728 may be configured as unidirectional communication interfaces as indicated by the arrow for the communication channel 3713 in FIG. 38 pointing from the source device 3712 to the destination device 3714, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 3721 and provide decoded picture data 3731 or a decoded picture 3731.

The post-processor 3732 of destination device 3714 is configured to post-process the decoded picture data 3731 (also called reconstructed picture data), e.g. the decoded picture 3731, to obtain post-processed picture data 3733, e.g. a post-processed picture 3733. The post-processing performed by the post-processing unit 3732 may comprise, e.g. color format conversion (e.g. from YcbCr to RGB), color correction, trimming, or re-sampling, or any other processing, e.g. for preparing the decoded picture data 3731 for display, e.g. by display device 3734.

The display device 3734 of the destination device 3714 is configured to receive the post-processed picture data 3733 for displaying the picture, e.g. to a user or viewer. The display device 3734 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LcoS), digital light processor (DLP) or any kind of other display.

Although FIG. 38 depicts the source device 3712 and the destination device 3714 as separate devices, embodiments of devices may also comprise both or both functionalities, the source device 3712 or corresponding functionality and the destination device 3714 or corresponding functionality. In such embodiments the source device 3712 or corresponding functionality and the destination device 3714 or corresponding functionality may be implemented using the same hardware and/or software or by separate hardware and/or software or any combination thereof.

As will be apparent for the skilled person based on the description, the existence and (exact) split of functionalities of the different units or functionalities within the source device 3712 and/or destination device 3714 as shown in FIG. 38 may vary depending on the actual device and application.

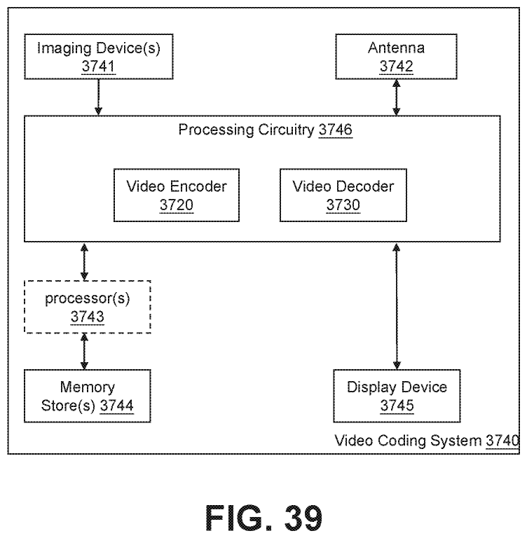

The encoder 3720 (e.g. a video encoder 3720) or the decoder 3730 (e.g. a video decoder 3730) or both encoder 3720 and decoder 3730 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 3720 may be implemented via processing circuitry 3746 to embody the various modules Including the neural network or its parts. The decoder 3730 may be implemented via processing circuitry 3746 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 3720 and video decoder 3730 may be integrated as part of a combined encoder/decoder (CODEC) in a single device, for example, as shown in FIG. 39.

Source device 3712 and destination device 3714 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 3712 and the destination device 3714 may be equipped for wireless communication. Thus, the source device 3712 and the destination device 3714 may be wireless communication devices.

In some cases, video coding system 3710 illustrated in FIG. 38 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

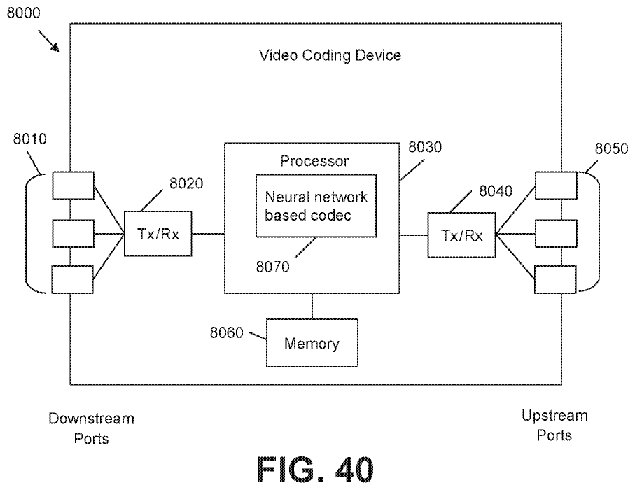

FIG. 40 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 3730 of FIG. 38 or an encoder such as video encoder 3720 of FIG. 38.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

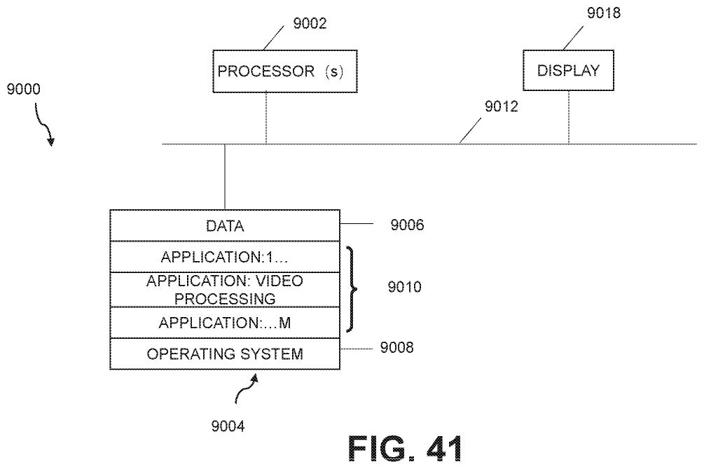

FIG. 41 is a simplified block diagram of an apparatus that may be used as either or both of the source device 3712 and the destination device 3714 from FIG. 38 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

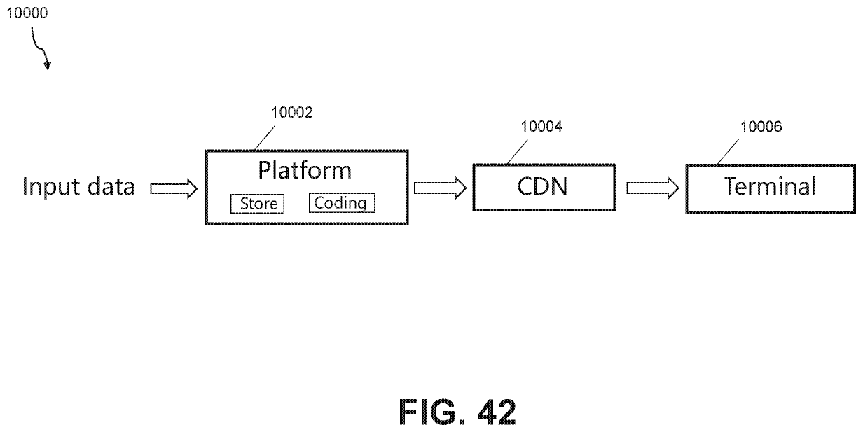

FIG. 42 is a block diagram of a video coding system 10000 according to an embodiment of the disclosure. A platform 10002 in the system 10000 can be could sever or local sever. Alternatively, the platform 10002 can be any other type of device, or multiple devices, capable of calculation, storing, transcoding, encryption, rendering, decoding or encoding. Although the disclosed implementations can be practiced with a single platform as shown, e.g., the platform 10002, advantages in speed and efficiency can be achieved using more than one platform.

A content delivery network (CDN) 10004 in the system 10000 can be a group of geographically distributed servers. Alternatively, the CDN 10004 can be any other type of device, or multiple devices, capable of data buffering, scheduling, dissemination or speed up the delivery of web content by bringing it closer to where users are. Although the disclosed implementations can be practiced with a single CDN as shown, e.g., the CDN 10004, advantages in speed and efficiency can be achieved using more than one CDN.

A terminal 10006 in the apparatus 10000 can be a mobile phone, computer, television, laptop, camera. Alternatively, the terminal 10006 can be any other type of device, or multiple devices, capable of displaying video or image.

The present application provides a computer readable storage medium including instructions. When the instructions run on an electronic device, the electronic device is enabled to perform the aforementioned method.

The present application provides a chip system. The chip system includes a memory and a processor, and the memory is configured to store a computer program, and the processor is configured to invoke the computer program from the memory and run the computer program, so that an electronic device on which the chip system is disposed performs the aforementioned method.

The present application provides a computer program product. When the computer program product runs on an electronic device, the electronic device is enabled to perform the aforementioned method.

In the embodiments of the present application, “at least one” means one or more, and “a plurality of” means two or more. The term “and/or” describes an association relationship between associated objects and represents that three relationships may exist. For example, A and/or B may represent the following three cases: only A exists, both A and B exist, and only B exists, where A and B may be singular or plural. The character “/” generally indicates an “or” relationship between the associated objects. “At least one of the following” and a similar expression thereof refer to any combination of these items, including any combination of one item or a plurality of items. For example, at least one of a, b, and c may indicate: a, b, c, a and b, a and c, b and c, or a, b, and c, where a, b, and c may be singular or plural.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A decoding method, comprising:
obtaining an entropy segment i from a bitstream, wherein the entropy segment i is one entropy segment among N entropy segments, the N entropy segments constitute a representation of an input data in a latent space, the entropy segment i has no overlap region with an adjacent entropy segment, N is a positive integer greater than one, i=1, . . . , N;
determining a synthesis segment i according to at least one of the entropy segment i and the at least one entropy segment adjacent to the entropy segment i, wherein the synthesis segment i comprises at least one overlap region with an adjacent synthesis segment; and
determining a reconstructed segment i according to the synthesis segment i by performing a decoding network, wherein the reconstructed segment i has no overlap region with an adjacent reconstructed segment.

2. The method according to claim 1, wherein the obtaining an entropy segment i from a bitstream comprises:
determining a location information corresponding to the entropy segment i according to an input segment corresponding to the entropy segment i, wherein the input segment corresponding to the entropy segment i is one input segment among M input segments, the M input segments constitute the input data, each of the M input segments comprises at least one overlap region with its adjacent input segment, M is a positive integer greater than one; and
obtaining the entropy segment i according to the location information corresponding to the entropy segment i from the bitstream.

3. The method according to claim 2, wherein the determining a location information corresponding to the entropy segment i according to an input segment corresponding to the entropy segment i, comprises:
determining a shifted segment i according to the input segment corresponding to the entropy segment i and a size of the overlap region;
determining a shifted latent segment i according to the shifted segment i and an alignment parameter of a synthesis transform in the decoding network; and
determining the location information corresponding to the entropy segment i according to the shifted latent segment i and the shifted segment i.

4. The method according to claim 1, wherein the determining a synthesis segment i according to the entropy segment i and/or at least one entropy segment adjacent to the entropy segment i, comprises:
determining location information of the synthesis segment i according to an alignment parameter of a synthesis transform in the decoding network and an input segment corresponding to the synthesis segment i, wherein the input segment corresponding to the synthesis segment i is one input segment among M input segments, the M input segments constitute the input data, each of the M input segments comprises at least one overlap region with its adjacent input segment; and
determining, according to the location information of the synthesis segment i, elements of the synthesis segment i from the entropy segment i and/or at least one entropy segment adjacent to the entropy segment i.

5. The method according to claim 1, wherein before the obtaining an entropy segment i from a bitstream, the method further comprises:
obtaining a segment flag information from the bitstream, wherein the segment flag information indicates that the bitstream comprises N entropy segments.

6. The method according to claim 1, wherein the method further comprises:
obtaining a first context segment i according to the entropy segment i and/or at least one entropy segment adjacent to the entropy segment i, wherein the first context segment is obtained from the bitstream and comprises at least one overlap region with an adjacent first context segment;
obtaining a second context segment i according to the entropy segment and/or at least one entropy segment adjacent to the entropy segment i, wherein the second context segment represents an input prediction segment i corresponding to the entropy segment i and comprises at least one overlap region with an adjacent second context segment;
inputting the first context segment i and the second context segment i to a context model to form the synthesis segment i; and
determining the reconstructed segment i according to the synthesis segment i by inputting the synthesis segment i into the decoding network, wherein the reconstructed segment i has no overlap region with its adjacent reconstructed segment.

7. The method according to claim 6, wherein the first context segment i has the same spatial dimension as the synthesis segment i.

8. The method according to claim 6, wherein the first context segment i and the second context segment i each have the same total numbers of elements.

9. The method according to claim 6, wherein the input prediction segment is the output of a hyper-decoder of a variational auto encoder model.

10. The method according to claim 6, wherein the spatial dimension of the second context segment i is a quarter of the spatial dimension of the first context segment i, and wherein the second context segment i has 4 times the number of channels than the first context segment.

11. The method according to claim 6, wherein the first context segment i represents a residual of the input data in the latent space.

12. The method according to claim 1, wherein the at least one overlap region of the synthesis segment is disregarded in the determination of the reconstructed segment.

13. The method according to claim 1, wherein the input data is derived from an input image and wherein each reconstructed segment corresponds to a tile of the input image.

14. An encoding method, comprising:
dividing an input data into M input segments, wherein each of the M input segments comprises at least one overlap region with an adjacent input segment, M is a positive integer greater than one;
determining M analysis segments by processing the M input segments using an encoding network, wherein the M analysis segments and the M input segments are in one-to-one correspondence;
determining a representation of the input data in a latent space according to the M analysis segments and the M input segments;
dividing the representation of the input data into N entropy segments, wherein each of the N entropy segments has no overlap region with an adjacent entropy segment, N is a positive integer greater than one; and
determining a bitstream by encoding the N entropy segments.

15. The method according to claim 614, wherein the determining a representation of the input data in a latent space according to the M analysis segments, comprises:
determining M core segments according to the M analysis segments and the M input segments, wherein a j^{th} core segments among the M core segments is determined according to a j^{th} analysis segments among the M analysis segments and a j^{th} input segment among the M input segments, j=1, . . . , M, each of the M core segments has no overlap region with its adjacent core segments; and
determining the representation of the input data by constitute the M core segments.

16. The method according to claim 614, wherein the dividing the representation of the input data into N entropy segments, comprises:
determining location information of each of the N entropy segments; and
dividing, according to location information of the each of the N entropy segments, the representation of the input data into the N entropy segments.

17. The method according to claim 816, wherein the determining location information of each of the N entropy segments, comprises:
determining N shifted segments according to the M input segments;
determining N shifted latent segments according to the N shifted segments and an alignment parameter of an analysis transform in the encoding network; and
determining the location information of the each of the N entropy segments according to the N shifted latent segments and the N shifted segments.

18. The method according to claim 614, wherein the method further comprises:
determining a segment flag information in the bitstream, wherein segment flag information indicates that the bitstream comprises N entropy segments.

19. The method according to claim 14, wherein the method further comprises:
From the determined representation of the input data in the latent space, determining a latent segment i, i=1, . . . , M, wherein the latent segment i comprises at least one overlap region with its adjacent latent segment;
obtaining an input prediction segment i according to the latent segment i, the input prediction segment i comprising at least one overlap region with an adjacent input prediction segment;
inputting the latent segment i and the input prediction segment i to a context model to output an output segment i of M output segments, wherein the output segment i has no overlap region with its adjacent output segment;
dividing the M output segments into N entropy segments, wherein each of the N entropy segments has no overlap region with its adjacent entropy segment; and
determining the bitstream by encoding the N entropy segments.

20. The method according to claim 19, wherein the latent segment i has the same spatial dimension as the output segment i.

21. The method according to claim 19, wherein the latent segment i and the input prediction segment i each have the same total numbers of elements.

22. The method according to claim 19, wherein the input prediction segment is the output of a hyper-decoder of a variational auto encoder model.

23. The method according to claim 19, wherein the spatial dimension of the input prediction segment i is a quarter of the spatial dimension of the latent segment i, and wherein the input prediction segment i has 4 times the number of channels than the latent segment.

24. The method according to claim 19, wherein the output segment i represents a residual of the input data in the latent space.

25. The method according to claim 19, wherein the at least one overlap region of the latent segment is disregarded in the determination of the output segments.

26. The method according to claim 19, wherein the input data is derived from an input image and wherein each latent segment corresponds to a tile of the input image.

27. An electronic device, comprising:
an obtaining unit, configured to obtain an entropy segment i from a bitstream, wherein the entropy segment i is one entropy segment among N entropy segments, the N entropy segments constitute a representation of an input data in a latent space, the entropy segment i has no overlap region with an adjacent entropy segment, N is a positive integer greater than one, i=1, . . . , N;
a processing unit, configured to determine a synthesis segment i according to at least one of the entropy segment i and the at least one entropy segment adjacent to the entropy segment i, wherein the synthesis segment i comprises at least one overlap region with an adjacent synthesis segment; and
the processing unit, further configured to determine a reconstructed segment i according to the synthesis segment i by performing a decoding network, wherein the reconstructed segment i has no overlap region with an adjacent reconstructed segment.

28. An electronic device, comprising:
a dividing unit, configured to divide an input data into M input segments, wherein each of the M input segments comprises at least one overlap region with an adjacent input segment, M is a positive integer greater than one;
a processing unit configured to determine M analysis segments by processing the M input segments using an encoding network, wherein the M analysis segments and the M input segments are in one-to-one correspondence;
the processing unit, further configured to determine a representation of the input data in a latent space according to the M analysis segments and the M input segments;
the processing unit, further configured to divide the representation of the input data into N entropy segments, wherein each of the N entropy segments has no overlap region with an adjacent entropy segment, N is a positive integer greater than one; and
the processing unit, further configured to determine a bitstream by encoding the N entropy segments.

29. A non-transitory computer readable medium, wherein the computer readable medium stores instructions, and when the instructions run on an electronic device, the electronic device is enabled to perform the method according to claim 1.

30. A non-transitory computer readable medium, wherein the computer readable medium stores instructions, and when the instructions run on an electronic device, the electronic device is enabled to perform the method according to claim 14.
